(19) United States
(12) Patent Application Publication
(10) Pub. No.: US 2025/0247888 A1
(43) Pub. Date: Jul. 31, 2025

(54) TECHNIQUES FOR RANDOM ACCESS IN SUB-BAND FULL DUPLEX SYMBOL

(71) Applicant: QUALCOMM Incorporated, San Diego, CA (US)

(72) Inventors: Qian ZHANG, Basking Ridge, NJ (US); Muhammad Sayed Khairy ABDELGHAFFAR, San Jose, CA (US); Abdelrahman Mohamed Ahmed Mohamed IBRAHIM, San Diego, CA (US); Ahmed Attia ABOTABL, San Diego, CA (US)

(21) Appl. No.: 18/428,753

(22) Filed: Jan. 31, 2024

(51) Int. Cl. H04W 74/0833; H04L 5/14

(52) U.S. Cl. CPC H04W 74/0833; H04L 5/14

(57) ABSTRACT

Various aspects of the present disclosure generally relate to wireless communication. In some aspects, a user equipment (UE) may identify a set of valid RACH occasions of a plurality of RACH occasions, wherein the set of valid RACH occasions includes one or more first valid RACH occasions on one or more uplink symbols and an uplink sub-band in a downlink symbol. The UE may identify a first set of synchronization signal block (SSB) indexes associated with the one or more first valid RACH occasions and a second set of SSB indexes associated with the one or more second valid RACH occasions. The UE may transmit a RACH message on a valid RACH occasion of the set of valid RACH occasions, the valid RACH occasion corresponding to an SSB index. Numerous other aspects are described.

### FIELD OF THE DISCLOSURE

Aspects of the present disclosure generally relate to wireless communication and specifically relate to techniques, apparatuses, and methods for random access in sub-band full duplex symbol.

### DESCRIPTION OF RELATED ART

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some aspects, a method of wireless communication performed by a user equipment (UE) includes receiving a sub-band full duplex (SBFD) configuration that indicates an uplink sub-band in a downlink symbol; receiving a random access channel (RACH) configuration, wherein the RACH configuration indicates a plurality of RACH occasions; identifying a set of valid RACH occasions of the plurality of RACH occasions, wherein the set of valid RACH occasions includes one or more first valid RACH occasions on one or more uplink symbols and one or more second valid RACH occasions on the uplink sub-band in the downlink symbol; identifying a first set of synchronization signal block (SSB) indexes associated with the one or more first valid RACH occasions; identifying, after identifying the first set of SSB indexes, a second set of SSB indexes associated with the one or more second valid RACH occasions; receiving an SSB associated with an SSB index of the first set of SSB indexes or the second set of SSB indexes; and transmitting a RACH message on a valid RACH occasion of the set of valid RACH occasions, the valid RACH occasion corresponding to the SSB index.

In some aspects, a method of wireless communication performed by a network node includes transmitting an SBFD configuration that indicates an uplink sub-band in a downlink symbol; transmitting a RACH configuration, wherein the RACH configuration indicates a plurality of RACH occasions; identifying a set of valid RACH occasions of the plurality of RACH occasions; identifying one or more sets of SSB indexes associated with the set of valid RACH occasions; transmitting an SSB associated with an SSB index of the one or more sets of SSB indexes; and monitoring for a RACH message on a valid RACH occasion of the set of valid RACH occasions, the valid RACH occasion corresponding to the SSB index.

In some aspects, an apparatus for wireless communication at a UE includes one or more memories; and one or more processors, coupled to the one or more memories, configured to cause the UE to: receive an SBFD configuration that indicates an uplink sub-band in a downlink symbol; receive a RACH configuration, wherein the RACH configuration indicates a plurality of RACH occasions; identify a set of valid RACH occasions of the plurality of RACH occasions, wherein the set of valid RACH occasions includes one or more first valid RACH occasions on one or more uplink symbols and one or more second valid RACH occasions on the uplink sub-band in the downlink symbol; identify a first set of SSB indexes associated with the one or more first valid RACH occasions; identify, after identifying the first set of SSB indexes, a second set of SSB indexes associated with the one or more second valid RACH occasions; receive an SSB associated with an SSB index of the first set of SSB indexes or the second set of SSB indexes; and transmit a RACH message on a valid RACH occasion of the set of valid RACH occasions, the valid RACH occasion corresponding to the SSB index.

In some aspects, an apparatus for wireless communication at a network node includes one or more memories; and one or more processors, coupled to the one or more memories, configured to cause the network node to: transmit an SBFD configuration that indicates an uplink sub-band in a downlink symbol; transmit a RACH configuration, wherein the RACH configuration indicates a plurality of RACH occasions; identify a set of valid RACH occasions of the plurality of RACH occasions; identify one or more sets of SSB indexes associated with the set of valid RACH occasions; transmit an SSB associated with an SSB index of the one or more sets of SSB indexes; and monitor for a RACH message on a valid RACH occasion of the set of valid RACH occasions, the valid RACH occasion corresponding to the SSB index.

In some aspects, a non-transitory computer-readable medium storing a set of instructions for wireless communication includes one or more instructions that, when executed by one or more processors of a UE, cause the UE to: receive an SBFD configuration that indicates an uplink sub-band in a downlink symbol; receive a RACH configuration, wherein the RACH configuration indicates a plurality of RACH occasions; identify a set of valid RACH occasions of the plurality of RACH occasions, wherein the set of valid RACH occasions includes one or more first valid RACH occasions on one or more uplink symbols and one or more second valid RACH occasions on the uplink sub-band in the downlink symbol; identify a first set of SSB indexes associated with the one or more first valid RACH occasions; identify, after identifying the first set of SSB indexes, a second set of SSB indexes associated with the one or more second valid RACH occasions; receive an SSB associated with an SSB index of the first set of SSB indexes or the second set of SSB indexes; and transmit a RACH message on a valid RACH occasion of the set of valid RACH occasions, the valid RACH occasion corresponding to the SSB index.

In some aspects, a non-transitory computer-readable medium storing a set of instructions for wireless communication includes one or more instructions that, when executed by one or more processors of a network node, cause the network node to: transmit an SBFD configuration that indicates an uplink sub-band in a downlink symbol; transmit a RACH configuration, wherein the RACH configuration indicates a plurality of RACH occasions; identify a set of valid RACH occasions of the plurality of RACH occasions; identify one or more sets of SSB indexes associated with the set of valid RACH occasions; transmit an SSB associated with an SSB index of the one or more sets of SSB indexes; and monitor for a RACH message on a valid RACH occasion of the set of valid RACH occasions, the valid RACH occasion corresponding to the SSB index.

In some aspects, an apparatus for wireless communication includes means for receiving an SBFD configuration that indicates an uplink sub-band in a downlink symbol; means for receiving a RACH configuration, wherein the RACH configuration indicates a plurality of RACH occasions; means for identifying a set of valid RACH occasions of the plurality of RACH occasions, wherein the set of valid RACH occasions includes one or more first valid RACH occasions on one or more uplink symbols and one or more second valid RACH occasions on the uplink sub-band in the downlink symbol; means for identifying a first set of SSB indexes associated with the one or more first valid RACH occasions; means for identifying, after identifying the first set of SSB indexes, a second set of SSB indexes associated with the one or more second valid RACH occasions; means for receiving an SSB associated with an SSB index of the first set of SSB indexes or the second set of SSB indexes; and means for transmitting a RACH message on a valid RACH occasion of the set of valid RACH occasions, the valid RACH occasion corresponding to the SSB index.

In some aspects, an apparatus for wireless communication includes means for transmitting an SBFD configuration that indicates an uplink sub-band in a downlink symbol; means for transmitting a RACH configuration, wherein the RACH configuration indicates a plurality of RACH occasions; means for identifying a set of valid RACH occasions of the plurality of RACH occasions; means for identifying one or more sets of SSB indexes associated with the set of valid RACH occasions; means for transmitting an SSB associated with an SSB index of the one or more sets of SSB indexes; and means for monitoring for a RACH message on a valid RACH occasion of the set of valid RACH occasions, the valid RACH occasion corresponding to the SSB index.

Some aspects described herein relate to a method of wireless communication performed by a user equipment (UE). The method may include receiving a sub-band full duplex (SBFD) configuration that indicates an uplink sub-band in a downlink symbol. The method may include receiving a random access channel (RACH) configuration, wherein the RACH configuration indicates a plurality of RACH occasions including at least one RACH occasion in the uplink sub-band. The method may include identifying a set of valid RACH occasions of the plurality of RACH occasions, wherein the set of valid RACH occasions includes one or more valid RACH occasions on one or more uplink symbols, and wherein the at least one RACH occasion in the uplink sub-band is invalid for the UE having an SBFD-aware status. The method may include transmitting a RACH message on a valid RACH occasion of the set of valid RACH occasions.

Some aspects described herein relate to an apparatus for wireless communication at a user equipment (UE). The apparatus may include one or more memories and one or more processors coupled to the one or more memories. The one or more processors may be configured to receive a sub-band full duplex (SBFD) configuration that indicates an uplink sub-band in a downlink symbol. The one or more processors may be configured to receive a random access channel (RACH) configuration, wherein the RACH configuration indicates a plurality of RACH occasions including at least one RACH occasion in the uplink sub-band. The one or more processors may be configured to identify a set of valid RACH occasions of the plurality of RACH occasions, wherein the set of valid RACH occasions includes one or more valid RACH occasions on one or more uplink symbols, and wherein the at least one RACH occasion in the uplink sub-band is invalid for the UE having an SBFD-aware status. The one or more processors may be configured to transmit a RACH message on a valid RACH occasion of the set of valid RACH occasions.

Some aspects described herein relate to a non-transitory computer-readable medium that stores a set of instructions for wireless communication by a user equipment (UE). The set of instructions, when executed by one or more processors of the UE, may cause the UE to receive a sub-band full duplex (SBFD) configuration that indicates an uplink sub-band in a downlink symbol. The set of instructions, when executed by one or more processors of the UE, may cause the UE to receive a random access channel (RACH) configuration, wherein the RACH configuration indicates a plurality of RACH occasions including at least one RACH occasion in the uplink sub-band. The set of instructions, when executed by one or more processors of the UE, may cause the UE to identify a set of valid RACH occasions of the plurality of RACH occasions, wherein the set of valid RACH occasions includes one or more valid RACH occasions on one or more uplink symbols, and wherein the at least one RACH occasion in the uplink sub-band is invalid for the UE having an SBFD-aware status. The set of instructions, when executed by one or more processors of the UE, may cause the UE to transmit a RACH message on a valid RACH occasion of the set of valid RACH occasions.

Some aspects described herein relate to an apparatus for wireless communication. The apparatus may include means for receiving a sub-band full duplex (SBFD) configuration that indicates an uplink sub-band in a downlink symbol. The apparatus may include means for receiving a random access channel (RACH) configuration, wherein the RACH configuration indicates a plurality of RACH occasions including at least one RACH occasion in the uplink sub-band. The apparatus may include means for identifying a set of valid RACH occasions of the plurality of RACH occasions, wherein the set of valid RACH occasions includes one or more valid RACH occasions on one or more uplink symbols, and wherein the at least one RACH occasion in the uplink sub-band is invalid for the apparatus having an SBFD-aware status. The apparatus may include means for transmitting a RACH message on a valid RACH occasion of the set of valid RACH occasions.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example UE in a wireless network.

FIG. 3 is a diagram illustrating an example disaggregated base station architecture in accordance with the present disclosure.

FIG. 4 is a diagram illustrating examples of full-duplex communication in a wireless network, in accordance with the present disclosure.

FIG. 5A is a diagram illustrating examples of different duplexing modes, and FIG. 5B is a diagram illustrating an example of sub-band full duplex (SBFD) activation, in accordance with the present disclosure.

FIG. 6 is a diagram illustrating an example of random access channel (RACH) configuration, in accordance with the present disclosure.

FIG. 7 is a diagram illustrating an example of signaling associated with RACH configuration for SBFD, in accordance with the present disclosure.

FIG. 8 is a diagram illustrating an example of valid and invalid RACH occasions (ROs) for SBFD-aware UEs and non-SBFD-aware UEs, in accordance with the present disclosure.

FIG. 9 is a diagram illustrating an example of ROs configured by a first RACH configuration and a second RACH configuration, in accordance with the present disclosure.

FIG. 10 is a diagram illustrating an example of mapping of synchronization signal block (SSB) indexes after valid RO identification, in accordance with the present disclosure.

FIG. 11 is a diagram illustrating an example of mapping of SSB indexes after valid RO identification, in accordance with the present disclosure.

FIG. 12 is a diagram illustrating an example of invalidating an RO based on a conflict with an SSB, in accordance with the present disclosure.

FIG. 13 is a diagram illustrating an example process performed, for example, at a UE or an apparatus of a UE, in accordance with the present disclosure.

FIG. 14 is a diagram illustrating an example process performed, for example, at a network node or an apparatus of a network node, in accordance with the present disclosure.

FIG. 15 is a diagram illustrating an example process performed, for example, at a UE or an apparatus of a UE, in accordance with the present disclosure.

FIG. 16 is a diagram of an example apparatus for wireless communication, in accordance with the present disclosure.

FIG. 17 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A user equipment (UE) may perform a random access procedure for various purposes, such as initial access, beam failure recovery, mobility, or the like. Random access (RA) involves the transmission of a RA channel (RACH) preamble on a RACH occasion (RO). ROs are generally configured for a given UE or signaled via cell-common signaling such as system information. A UE may determine whether a given RO is valid for the UE, which simplifies configuration of ROs by allowing the UE to invalidate certain ROs instead of configuring all signaling and resource allocation around certain invalid RO positions. In some contexts, synchronization signal blocks (SSBs) may be mapped to ROs, such that a UE can measure an SSB and transmit a RACH preamble on a corresponding RO.

Sub-band full duplex (SBFD) involves both uplink and downlink communication on the same bandwidth (e.g., the same channel bandwidth or the same transmission bandwidth). For example, a given carrier or bandwidth may be divided into one or more uplink sub-bands and one or more downlink sub-bands. SBFD operation may be configured in addition to time division duplexing (TDD) operation. For example, a first configuration (e.g., a TDD configuration) may designate certain time resources (e.g., slots or symbols) as uplink symbols, downlink symbols, or flexible symbols. A second configuration (e.g., an SBFD configuration) may designate one or more of the time resources as SBFD resources, which include at least one uplink sub-band and at least one flexible or downlink sub-band.

Different UEs may have different capabilities. For example, some UEs may be capable of interpreting and implementing SBFD configurations (referred to as SBFD-aware UEs or UEs having SBFD-aware status), and other UEs may not be capable of interpreting or implementing SBFD configurations (referred to as non-SBFD-aware UEs or UEs not having SBFD-aware status). Thus, configurations that are interpretable by one UE may not be interpretable by another UE. As one example, a RACH configuration that configures an RO in a downlink symbol with an uplink sub-band (i.e., an SBFD symbol) may be interpretable by an SBFD-aware UE, but may not be usable by a non-SBFD-aware UE (since a non-SBFD-aware UE cannot interpret an SBFD configuration that indicates the downlink symbol as an SBFD symbol, and thus may assume that the downlink symbol is incompatible with an RO). These differences may lead to inefficiency in RACH configuration and operation and to incompatibilities in network configuration. For example, a combination of ROs in SBFD resources and non-SBFD resources may lead to a situation where SSB indexes, mapped to certain ROs, are different for an SBFD-aware UE versus a non-SBFD-aware UE, since these two UEs may have different sets of ROs.

Aspects of the present disclosure relate generally to RACH configuration across SBFD resources and non-SBFD resources. Some aspects more specifically relate to definitions of whether ROs in downlink resources with uplink sub-bands for SBFD operation are valid. In some aspects, an RO in a downlink resource with an uplink sub-band for SBFD operation is considered valid for an SBFD-aware UE. In some other aspects, the RO is considered invalid (either by disallowing a configuration of such an RO, or by defining a configured RO as invalid for an SBFD-aware UE). Some aspects provide SSB index identification (sometimes referred to as SSB-to-RO mapping) across SBFD-aware UEs and non-SBFD-aware UEs, such that SSB indexes are consistent between the SBFD-aware UEs and the non-SBFD-aware UEs. For example, the SSB index identification may be performed by first mapping SSB indexes to ROs on uplink symbols, then mapping SSB indexes to ROs on SBFD symbols. In some aspects, the mapping of SSB indexes to ROs on SBFD symbols may use an SSB index of a nearest (such as a nearest earlier, or a nearest later) uplink symbol. “Mapping an SSB index to an RO” may be used interchangeably with “identifying an SSB index associated with an RO.”

Particular aspects of the subject matter described in this disclosure can be implemented to realize one or more of the following potential advantages. In some examples, by defining ROs in downlink resources with an uplink sub-band for SBFD operation as valid for an SBFD-aware UE, the described techniques can be used to increase the addressable space of ROs, thereby improving efficiency of random access. By defining such an RO as invalid by disallowing configuration of such an RO, implementation of SBFD-aware UEs is simplified. By defining such an RO, configured for an SBFD-aware UE, as invalid at the UE, resource configuration and operation of the network is simplified. By identifying (mapping) SSB indexes consistently across SBFD-aware UEs and non-SBFD-aware UEs, network operation is simplified and compatibility across UEs with different capabilities is improved. By first mapping SSB indexes to ROs on uplink symbols then ROs on SBFD symbols, a single RACH configuration across these different types of symbols can be used for SBFD-aware UEs, and network configuration operations are simplified. By using the SSB index of the nearest (or earlier or later) uplink symbol, repetition of SSB indexes is provided, thereby improving reliability.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

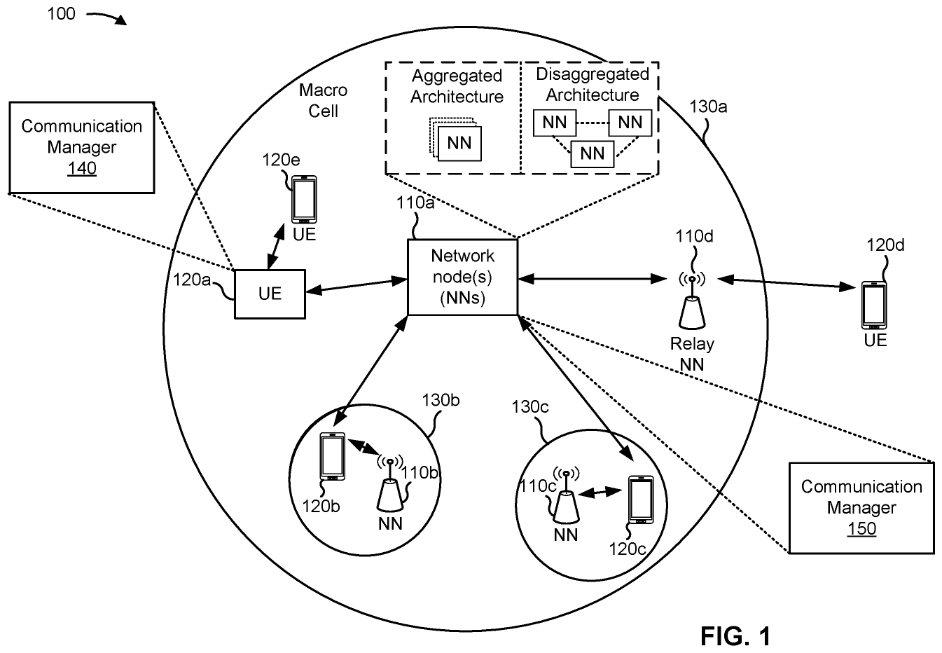

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FRI is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC) UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as multiple-TRP (mTRP) operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive an SBFD configuration that indicates an uplink sub-band in a downlink symbol; receive a RACH configuration, wherein the RACH configuration indicates a plurality of RACH occasions; identify a set of valid RACH occasions of the plurality of RACH occasions, wherein the set of valid RACH occasions includes one or more first valid RACH occasions on one or more uplink symbols and one or more second valid RACH occasions on the uplink sub-band in the downlink symbol; identify a first set of SSB indexes associated with the one or more first valid RACH occasions; identify, after identifying the first set of SSB indexes, a second set of SSB indexes associated with the one or more second valid RACH occasions; receive an SSB associated with an SSB index of the first set of SSB indexes or the second set of SSB indexes; and transmit a RACH message on a valid RACH occasion of the set of valid RACH occasions, the valid RACH occasion corresponding to the SSB index. Additionally, or alternatively, the communication manager 140 may perform one or more other operations described herein.

In some aspects, the network node 110 may include a communication manager 150. As described in more detail elsewhere herein, the communication manager 150 may transmit an SBFD configuration that indicates an uplink sub-band in a downlink symbol; transmit a RACH configuration, wherein the RACH configuration indicates a plurality of RACH occasions; identify a set of valid RACH occasions of the plurality of RACH occasions; identify one or more sets of SSB indexes associated with the set of valid RACH occasions; transmit an SSB associated with an SSB index of the one or more sets of SSB indexes; and monitor for a RACH message on a valid RACH occasion of the set of valid RACH occasions, the valid RACH occasion corresponding to the SSB index. Additionally, or alternatively, the communication manager 150 may perform one or more other operations described herein.

As indicated above, FIG. 1 is provided as an example. Other examples may differ from what is described with regard to FIG. 1.

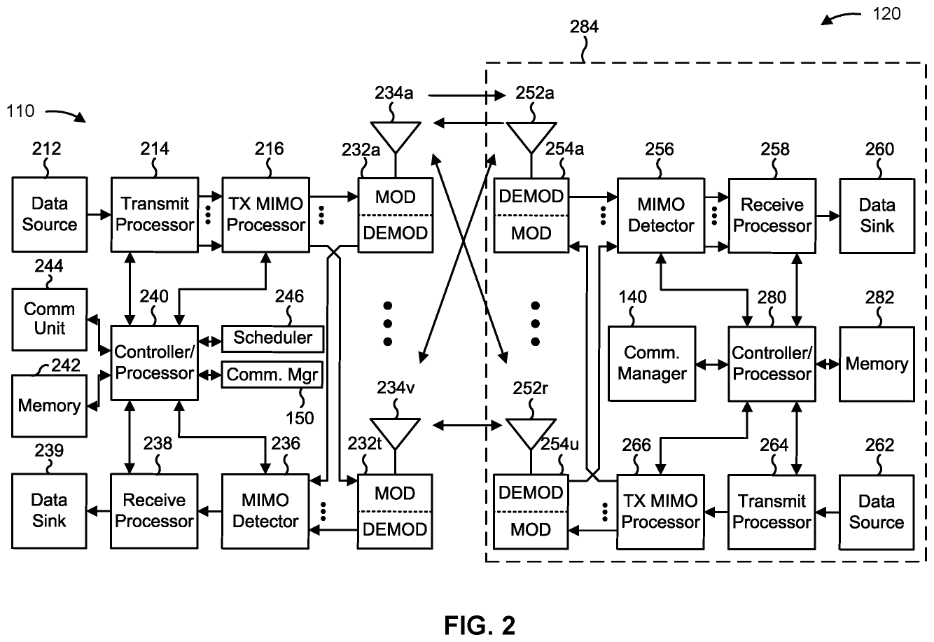

FIG. 2 is a diagram illustrating an example network node 110 in communication with an example UE 120 in a wireless network.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

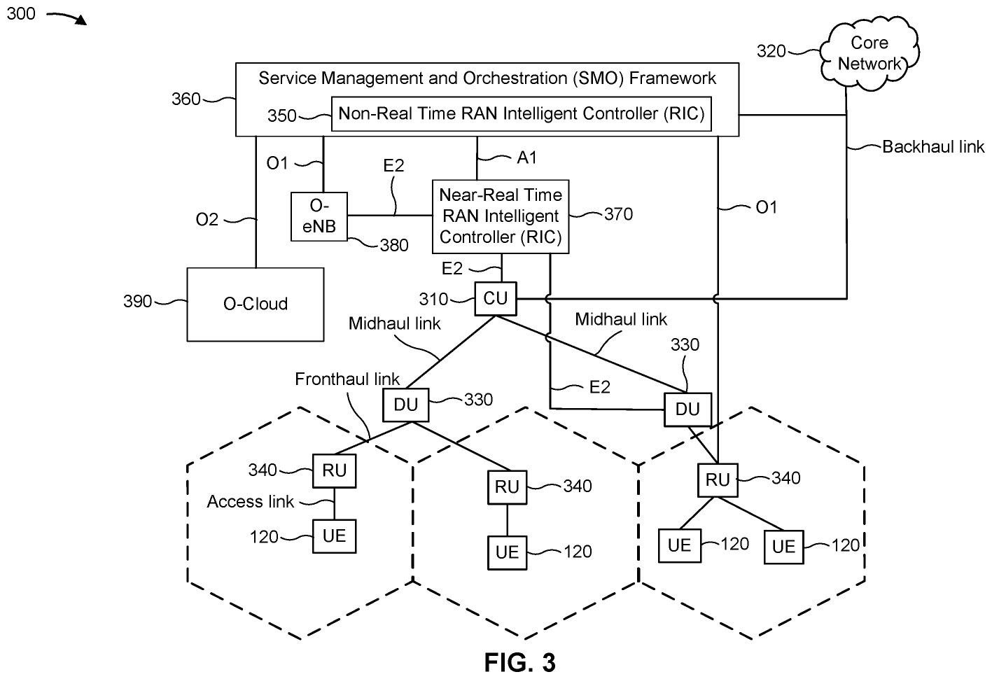

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

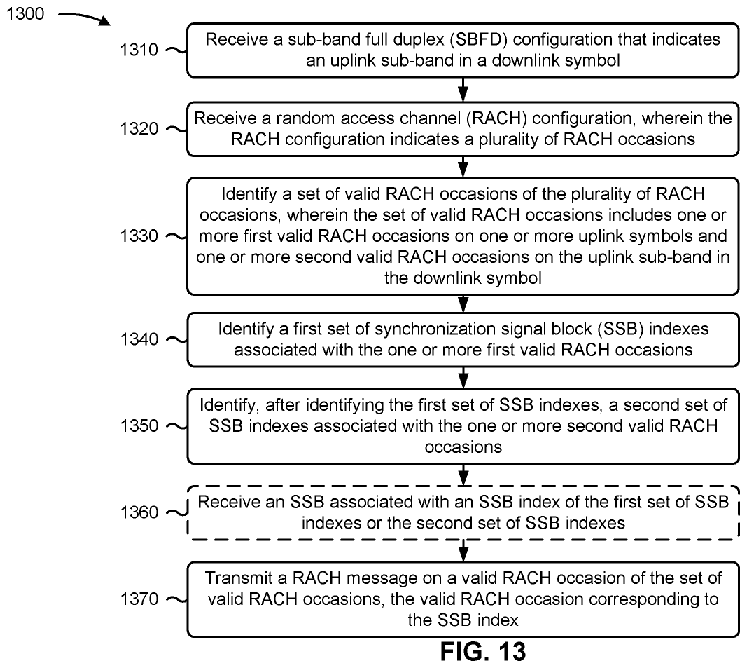

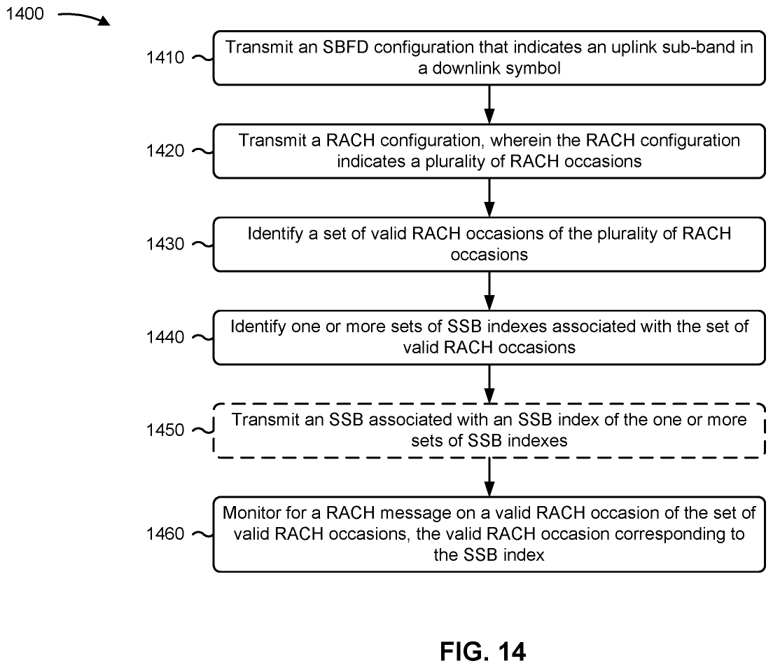

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with RO configuration in SBFD, as described in more detail elsewhere herein. For example, the controller/processor 240 of the network node 110, the controller/processor 280 of the UE 120, any other component(s) (or combinations of components) of FIG. 2, the CU 310, the DU 330, or the RU 340 may perform or direct operations of, for example, process 1300 of FIG. 13, process 1400 of FIG. 14, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1300 of FIG. 13, process 1400 of FIG. 14, or other processes as described herein. In some examples, executing instructions may include running the instructions, converting the instructions, compiling the instructions, and/or interpreting the instructions, among other examples.

In some aspects, the UE 120 includes means for receiving an SBFD configuration that indicates an uplink sub-band in a downlink symbol; means for receiving a RACH configuration, wherein the RACH configuration indicates a plurality of RACH occasions; means for identifying a set of valid RACH occasions of the plurality of RACH occasions, wherein the set of valid RACH occasions includes one or more first valid RACH occasions on one or more uplink symbols and one or more second valid RACH occasions on the uplink sub-band in the downlink symbol; means for identifying a first set of SSB indexes associated with the one or more first valid RACH occasions; means for identifying, after identifying the first set of SSB indexes, a second set of SSB indexes associated with the one or more second valid RACH occasions; means for receiving an SSB associated with an SSB index of the first set of SSB indexes or the second set of SSB indexes; and/or means for transmitting a RACH message on a valid RACH occasion of the set of valid RACH occasions, the valid RACH occasion corresponding to the SSB index. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting an SBFD configuration that indicates an uplink sub-band in a downlink symbol; means for transmitting a RACH configuration, wherein the RACH configuration indicates a plurality of RACH occasions; means for identifying a set of valid RACH occasions of the plurality of RACH occasions; means for identifying one or more sets of SSB indexes associated with the set of valid RACH occasions; means for transmitting an SSB associated with an SSB index of the one or more sets of SSB indexes; and/or means for monitoring for a RACH message on a valid RACH occasion of the set of valid RACH occasions, the valid RACH occasion corresponding to the SSB index. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

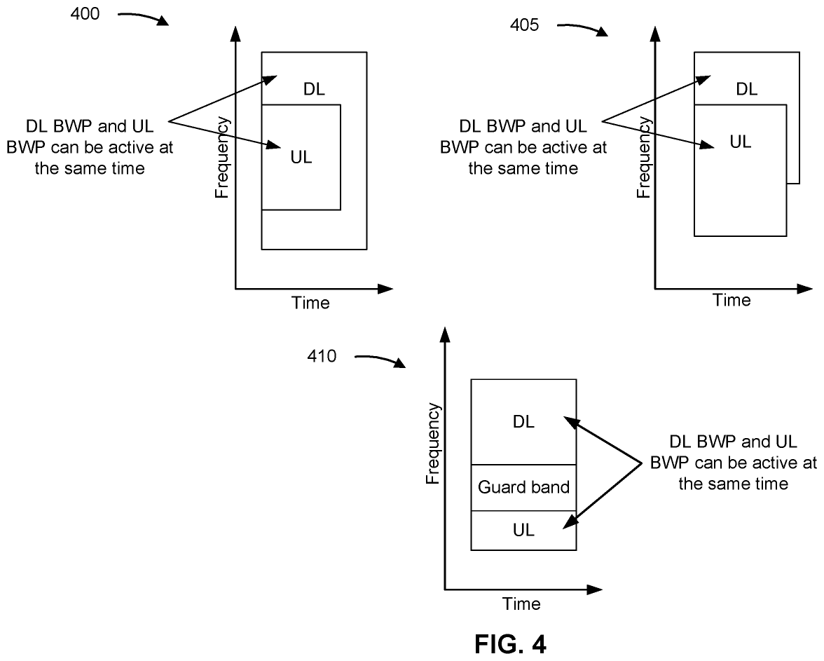

FIG. 4 is a diagram illustrating examples 400, 405, and 410 of full-duplex communication in a wireless network, in accordance with the present disclosure. “Full-duplex communication” in a wireless network refers to simultaneous bi-directional communication between devices in the wireless network. For example, a UE operating in a full-duplex mode may transmit an uplink communication and receive a downlink communication at the same time (e.g., in the same slot or the same symbol). “Half-duplex communication” in a wireless network refers to unidirectional communications (e.g., only downlink communication or only uplink communication) between devices at a given time (e.g., in a given slot or a given symbol).

As shown in FIG. 4, examples 400 and 405 show examples of in-band full-duplex (IBFD) communication. In IBFD, a UE may transmit an uplink communication to a base station and receive a downlink communication from the base station on the same time and frequency resources. As shown in example 400, in a first example of IBFD, the time and frequency resources for uplink communication may fully overlap with the time and frequency resources for downlink communication. As shown in example 405, in a second example of IBFD, the time and frequency resources for uplink communication may partially overlap with the time and frequency resources for downlink communication.

As further shown in FIG. 4, example 410 shows an example of sub-band full-duplex (SBFD) communication, which may also be referred to as “sub-band frequency division duplex (SBFDD)” or “flexible duplex.” In SBFD, a UE may transmit an uplink communication to a base station and receive a downlink communication from the base station at the same time, but on different frequency resources. For example, the different frequency resources may be sub-bands of a frequency band, such as a time division duplexing band. In this case, the frequency resources used for downlink communication may be separated from the frequency resources used for uplink communication, in the frequency domain, by a guard band.

In general, as described herein, utilizing a full-duplexing communication mode may provide reduced latency by allowing a downlink transmission to occur in an uplink-only symbol or slot and/or by allowing an uplink transmission to occur in a downlink-only symbol or slot. In addition, full-duplex communication may enhance spectral efficiency or throughput per cell or per UE and/or enable more efficient resource utilization by simultaneously utilizing time and frequency resources for downlink and uplink communication.

In some aspects, a first UE and a second UE may communicate with a first network node operating in a full-duplexing mode, with the first UE and the second UE operating in a half-duplexing mode. For example, the first UE may transmit one or more uplink transmissions to the first network node, and the second UE may concurrently receive one or more downlink transmissions from the first network node.

In some aspects, a first UE may communicate with a first network node in a full-duplexing mode. For example, the first UE may receive one or more downlink transmissions from the first network node, and the first UE may concurrently transmit one or more uplink transmissions to the first network node. Accordingly, the first network node and the first UE are both operating in a full-duplexing mode. In some examples, the first network node may also communicate with a second UE operating in a half-duplex mode. In some aspects, the full-duplex communication may be performed in an SBFD mode, where a component carrier bandwidth is divided into non-overlapping uplink and downlink sub-bands, or in an IBFD mode, where uplink and downlink resources fully or partially overlap.

In some aspects, a first UE may communicate with a first network node and a second network node in a full-duplexing mode (e.g., a multi-TRP mode). For example, the first UE may transmit one or more uplink transmissions to the first network node, and the first UE may concurrently receive one or more downlink transmissions from the second network node. Accordingly, the first UE is operating in a full-duplexing mode, and the first and second network nodes are both operating in a half-duplexing mode. In this example, the full-duplex communication may be performed in an SBFD mode, where a component carrier bandwidth is divided into non-overlapping uplink and downlink sub-bands, or in an IBFD mode, where uplink and downlink resources fully or partially overlap.

As indicated above, FIG. 4 is provided as an example. Other examples may differ from what is described with respect to FIG. 4.

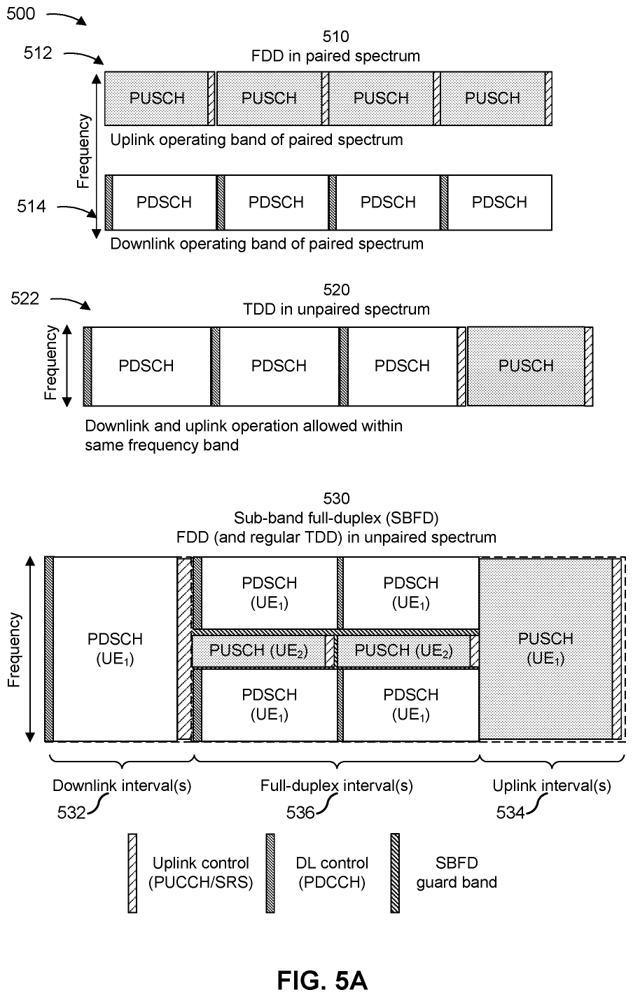

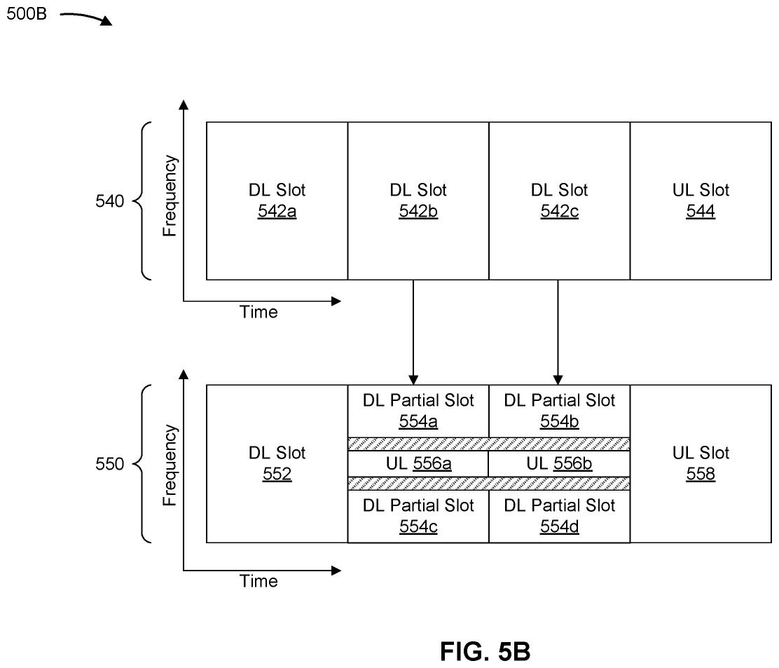

FIG. 5A is a diagram illustrating examples 500 of different duplexing modes, and FIG. 5B is a diagram illustrating an example 500B of SBFD activation, in accordance with the present disclosure. For example, as described in further detail herein, FIG. 5A illustrates an example 510 of an FDD mode that may be used in paired spectrum, an example 520 of a TDD mode that may be used in unpaired spectrum, and an example 530 of an SBFD mode that may be used in unpaired spectrum, and FIG. 5B illustrates an example 500B of techniques that may be used to activate the SBFD mode.

In some aspects, a wireless communication standard and/or governing body may generally specify one or more duplexing modes in which a wireless spectrum is to be used. For example, 3GPP may specify how wireless spectrum is to be used for the 5G/NR or 6G radio access technology and interface. As an example, a specification may indicate whether a band is to be used as paired spectrum in an FDD mode or as unpaired spectrum in a TDD mode.

For example, as shown by example 510, paired spectrum in the FDD mode may use a first frequency region 512 (or channel) for uplink communication and a second frequency region 514 (or channel) for downlink communication. In such cases, the frequency regions or channels used for uplink communication and downlink communication do not overlap, have different center frequencies, and have sufficient separation to prevent interference between the downlink communication and the uplink communication. For example, paired spectrum in FDD mode may include an uplink operating band and a downlink operating band that are configured to use non-overlapped frequency regions separated by a guard band. Accordingly, when operating in the FDD mode in paired spectrum, a network node or a UE with full-duplex capabilities may perform concurrent transmit and receive operations using the separate operating bands allocated to downlink and uplink communication. For example, paired bands in NR include NR operating bands n1, n2, n3, n5, n7, n8, n12, n20, n25, and n28, as specified by 3GPP Technical Specification (TS) 38.101-1.

Alternatively, as shown by example 520, unpaired spectrum in the TDD mode may allow downlink and uplink operation within a single frequency region 522 (e.g., a single operating band). For example, when operating in TDD mode in unpaired spectrum, downlink communication and uplink communication may occur in the same frequency range. Some deployments may use TDD in the unpaired band, whereby some transmission time intervals (e.g., frames, slots, and/or symbols) are used for downlink communication only and other transmission time intervals are used for uplink communication only. In this case, substantially the entire bandwidth of a component carrier may be used for downlink communication or uplink communication, depending on whether the communication is performed in a downlink interval, an uplink interval, or a special interval (in which either downlink or uplink communication can be scheduled). Examples of unpaired bands include NR operating bands n40, n41, and n50, as specified by 3GPP TS 38.101-1. In some cases, uplink transmit power may be limited, meaning that UEs may be incapable of transmitting with enough power to efficiently utilize the full bandwidth of an uplink slot. This may be particularly problematic in large cells at the cell edge. Furthermore, using TDD may introduce latency relative to a full-duplex scheme in which uplink communications and downlink communications can be performed in the same time interval, because TDD restricts usage of a given transmission time interval to uplink or downlink communication only. Furthermore, using TDD may reduce spectral efficiency and/or reduce throughput by restricting usage of a given transmission time interval to uplink or downlink communication only.

Accordingly, as shown by example 530, an unpaired band may be configured in a full-duplexing mode to enable concurrent transmit and receive operations in unpaired spectrum (e.g., a TDD band). For example, in FIG. 5A, example 530 depicts an SBFD mode, which may be referred to herein as full-duplexing in a frequency division multiplexing (FDM) mode or using other suitable terminology, in order to enable TDD operation and/or FDD operation in unpaired spectrum. For example, as shown in FIG. 5A, an unpaired band configured in the SBFD mode may associate one or more transmission time intervals with downlink communication only (e.g., “D” slots), one or more transmission time intervals for uplink communication only (e.g., “U” slots), and one or more transmission time intervals for both downlink communication and uplink communication (e.g., “D+U” slots). Each transmission time interval may be associated with a control region, illustrated as a portion of a time interval with a diagonal fill for uplink control (e.g., a PUCCH) or a darker-shaded fill for downlink control (e.g., a PDCCH). Additionally, or alternatively, each time interval may be associated with a data region, which is shown as a PDSCH for downlink frequency regions or a PUSCH for uplink frequency regions.

In some aspects, an unpaired band configured in the SBFD mode may include one or more downlink-only time intervals 532 (referred to as a downlink resource or a legacy downlink resource), one or more uplink-only time intervals 534 (referred to as an uplink resource or a legacy uplink resource, and/or one or more full-duplex time intervals 536 (e.g., frames, subframes, slots, and/or symbols, among other examples) that are associated with an FDD configuration, referred to herein as an SBFD configuration. For example, as shown in FIG. 5A, the SBFD configuration associated with a full-duplex time interval may indicate one or more downlink frequency regions (or sub-bands) and one or more uplink frequency regions (or sub-bands) that are separated by a guard band. Accordingly, an SBFD configuration may divide an unpaired frequency band (e.g., one or more component carriers of an unpaired band) into uplink frequency regions, downlink frequency regions, and/or other regions (e.g., guard bands and/or the like), which may enable a network node or a UE with full-duplex capabilities to perform simultaneous transmit and receive operations during one or more time intervals that are divided into downlink and uplink sub-bands with a guard band separation to prevent the uplink transmission from causing self-interference with respect to downlink reception. In some aspects, the SBFD configuration may indicate a downlink resource to include an uplink sub-band for SBFD operation, such that a downlink-only time interval 532 is reconfigured or indicated as a full-duplex time interval 536.

As an example, in a given full-duplex time interval, a half-duplexing UE may either transmit using the uplink frequency region or receive in the downlink frequency region (e.g., a UE communicating in a half-duplexing mode may only receive in a downlink frequency region or transmit in an uplink frequency region during the full-duplex time intervals). Alternatively, a full-duplexing UE may transmit using the uplink frequency region and/or receive in the downlink frequency region. Additionally, or alternatively, a full-duplexing network node may transmit a downlink communication to a first UE within the downlink frequency regions(s) and simultaneously receive an uplink communication from a second UE in the uplink frequency region(s). In some aspects, the SBFD configuration may identify BWP configurations corresponding to the uplink frequency regions and the downlink frequency regions. For example, a respective BWP may be configured for each uplink frequency region and each downlink frequency region.

Additionally, or alternatively, full-duplexing may be enabled in unpaired spectrum in an IBFD mode, which may be referred to herein as full-duplexing in a spatial division multiplexing (SDM) mode. For example, in an IBFD or SDM mode, uplink communication may occur on time and frequency resources that fully overlap time and frequency resources allocated to downlink communication (e.g., all of the time and frequency resources available for uplink communication are also available for downlink communication), or time and frequency resources that partially overlap with time and frequency resources available for downlink communication (e.g., some time and frequency resources available for uplink communication are also available for downlink communication and some time and frequency resources available for uplink communication are uplink-only). In general, in the IBFD mode, full-duplex communication may be conditional on sufficient beam separation between an uplink beam and a downlink beam (e.g., uplink transmission may be from one antenna panel and downlink reception may be in another antenna panel) in order to minimize self-interference that may occur when a transmitted signal leaks into a receive port and/or when an object in a surrounding environment reflects a transmitted signal back to a receive port (e.g., causing a clutter echo effect).

In some cases, as described herein, one or more frequency regions that support SBFD communication may be configured to dynamically switch between operating in a TDD mode and an SBFD mode. For example, as shown in FIG. 5B, example 500B includes a first configuration 540 (e.g., a legacy or default configuration associated with the TDD mode). In some aspects, the first configuration 540 may indicate a first slot format pattern (sometimes called a TDD pattern) associated with a half-duplex mode (e.g., where each interval is downlink-only or uplink-only). The first slot format pattern may include one or more downlink intervals (e.g., shown as three downlink slots 542a, 542b, and 542c, although each downlink interval may correspond to a downlink symbol or another suitable transmission time interval for downlink communication), one or more flexible intervals (not shown), and/or one or more uplink intervals (e.g., shown as one uplink slot 544, although each uplink interval may correspond to an uplink symbol or another suitable transmission time interval for uplink communication). The first slot format pattern may repeat over time. In some aspects, a network node 110 may indicate the first slot format pattern to a UE 120 using one or more slot format indicators. A slot format indicator, for a slot, may indicate whether the corresponding slot is an uplink slot, a downlink slot, or a flexible slot (e.g., that can be used as an uplink or downlink slot).

A network node 110 may instruct (e.g., using an indication, such as an RRC message, a MAC-CE, or DCI) a UE 120 to switch from the first configuration 540 to a second configuration 550. As an alternative, the UE 120 may indicate to the network node 110 that the UE 120 is switching from the first configuration 540 to the second configuration 550. This switch may be performed for any number of reasons, such as changing load conditions, changing traffic profiles, or the like. In some examples, the second configuration 550 may indicate a second slot format pattern that repeats over time, similar to the first slot format pattern. In any of the aspects described above, the UE 120 may switch from the first configuration 540 to the second configuration 550 during a time period (e.g., a quantity of symbols and/or an amount of time (e.g., in ms)) based at least in part on an indication received from the network node 110 (e.g., before switching back to the first configuration 540). During that time period, the UE 120 may communicate using the second slot format pattern, and then may revert to using the first slot format pattern after the end of the time period. The time period may be indicated by the network node 110 (e.g., in the instruction to switch from the first configuration 540 to the second configuration 550, as described above) and/or based at least in part on a programmed and/or otherwise preconfigured rule. For example, the rule may be based at least in part on a table (e.g., defined in 3GPP specifications and/or another wireless communication standard) that associates different sub-carrier spacings (SCSs) and/or numerologies (e.g., represented by u and associated with corresponding SCSs) with corresponding time periods for switching configurations.

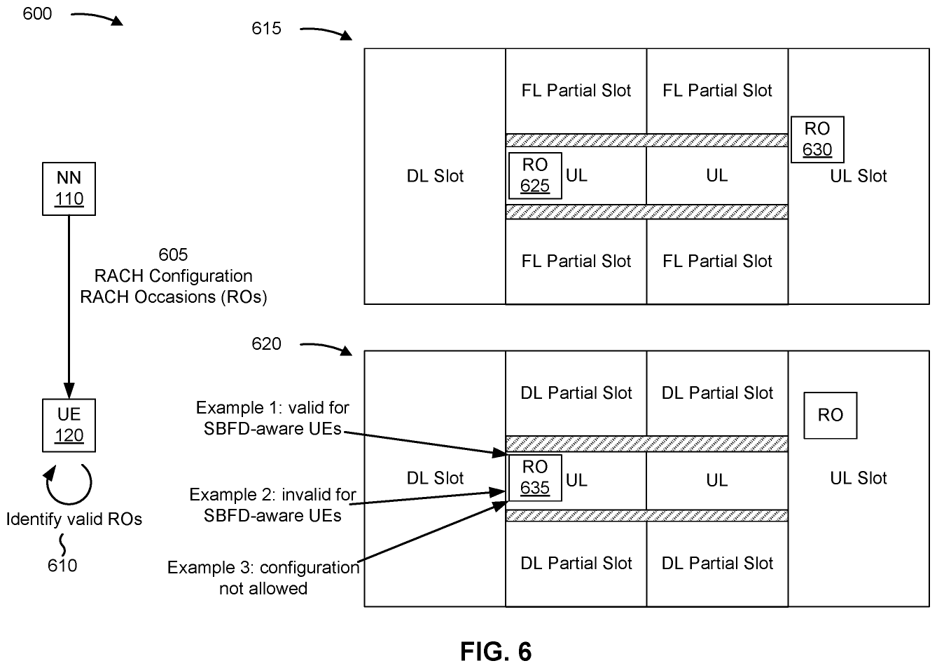

In example 500B, the second slot format pattern includes two SBFD slots in place of what were downlink slots in the first slot format pattern (although it is to be appreciated that in extension of this concept, for other examples, it is also possible that an SBFD slot(s) is arranged, mutatis mutandis, in place of what was instead an uplink slot(s) in other types of slot format patterns, e.g. refer to the relevant discussions below set out for FIG. 6). In example 500B, the second slot format pattern includes a downlink slot 552, which is followed by one or more SBFD slots that each include a partial slot (e.g., a portion or sub-band of a frequency allocated for use by the network node 110 and the UE 120) for downlink (e.g., partial slots 554a, 554b, 554c, and 554d, as shown) and a partial slot for uplink (e.g., partial slots 556a and 556b, as shown), which are followed by an uplink slot 558. Thus, the one or more SBFD slots may be referred to as downlink slots (or symbols) that include an uplink sub-band (556a, 556b) for SBFD operation. The UE 120 may operate using the second slot format pattern to transmit an uplink communication in an earlier slot (e.g., the second slot in sequence, shown as partial uplink slot 556a) as compared to using the first slot format pattern (e.g., the fourth slot in sequence, shown as uplink slot 544). Other examples may include additional or alternative changes. For example, the second configuration 550 may indicate an SBFD slot in place of what was an uplink slot in the first configuration 540 (e.g., uplink slot 544). In another example, the second configuration 550 may indicate a downlink slot or an uplink slot in place of what was an SBFD slot in the first configuration 540 (not shown in FIG. 5B). In yet another example, the second configuration 550 may indicate a downlink slot or an uplink slot in place of what was an uplink slot or a downlink slot, respectively, in the first configuration 540. An “SBFD slot” may refer to a slot in which an SBFD format is used. An SBFD format may include a slot format in which full duplex communication is supported (e.g., for both uplink and downlink communications), with one or more frequencies used for an uplink portion of the slot being separated from one or more frequencies used for a downlink portion of the slot by a guard band. In some aspects, the SBFD format may include a single uplink portion and a single downlink portion separated by a guard band. In some aspects, the SBFD format may include multiple downlink portions and a single uplink portion that is separated from the multiple downlink portions by respective guard bands (e.g., as shown in FIG. 5B). In some aspects, an SBFD format may include multiple uplink portions and a single downlink portion that is separated from the multiple uplink portions by respective guard bands. In some aspects, the SBFD format may include multiple uplink portions and multiple downlink portions, where each uplink portion is separated from a downlink portion by a guard band. In some aspects, operating using an SBFD mode may include activating or using a full duplex (FD) mode in one or more slots based at least in part on the one or more slots having the SBFD format. A slot may support the SBFD mode if an uplink bandwidth part and a downlink bandwidth part are permitted to be or are simultaneously active in the slot in an SBFD fashion (e.g., with guard band separation).

By switching from the first configuration 540 to the second configuration 550, the network node 110 and the UE 120 may experience increased quality and/or reliability of communications. For example, the network node 110 and the UE 120 may experience increased throughput (e.g., using a full-duplex mode), reduced latency (e.g., the UE 120 may be able to transmit an uplink and/or a downlink communication sooner using the second configuration 550 rather than the first configuration 540), and increased network resource utilization (e.g., by using both the downlink bandwidth part and the uplink bandwidth part simultaneously instead of only the downlink bandwidth part or the uplink bandwidth part).

As indicated above, FIGS. 5A and 5B are provided as examples. Other examples may differ from what is described with regard to FIGS. 5A and 5B, but the disclosed concept of enabling SBFD communications is nonetheless applicable to those other examples.

FIG. 6 is a diagram illustrating an example 600 of random access channel (RACH) configuration, in accordance with the present disclosure. As shown in FIG. 6, a network node 110 may transmit, and a UE 120 may receive, a RACH configuration 605. For example, the RACH configuration 605 may include or be included in RRC signaling, MAC signaling, DCI, or a combination thereof.

The RACH configuration 605 may indicate a number of RACH occasions (ROs) (sometimes referred to as physical RACH (PRACH) occasions or random access occasions). In some aspects, the RACH configuration 605 may include a RACH-ConfigCommon or RACH-ConfigCommonTwoStepRA parameter. For example, the RACH configuration 605 may indicate a quantity of ROs. As another example, the RACH configuration 605 may indicate preamble indexes to use in ROs. As another example, the RACH configuration 605 may indicate a subcarrier spacing. As another example, the RACH configuration 605 may indicate a number of RA preambles. As another example, the RACH configuration 605 may indicate a number of SSBs per RO. As another example, the RACH configuration 605 may include one or more parameters that indicate time and/or frequency locations of one or more ROs.

As shown by reference number 610, the UE 120 may determine whether an RO, indicated by the RACH configuration 605, is valid. The UE 120 may only transmit a random access preamble on a valid RO. Furthermore, the network node 110 may schedule downlink and uplink communications, and may generate a TDD configuration, in a fashion that does not cause conflict with (e.g., overlap) a valid RO.

One or more rules may indicate whether a given RO is valid. In some examples, in FDD (e.g., paired spectrum), all ROs are considered valid. In some examples, in TDD (e.g., unpaired spectrum), a validity determination may be based on whether a TDD configuration has been configured and/or one or more other factors, such as whether the RO is in an uplink symbol, or whether the RO is separated from other channels or symbols by at least a threshold.

In some aspects, the validity of an RO may be based on a capability of the UE 120. For example, some UEs 120 may have a capability for SBFD operation, referred to as “SBFD-aware UEs”. A UE 120 with a capability for SBFD operation may be capable of interpreting and applying an SBFD configuration. For example, a UE 120 with a capability for SBFD operation may receive an SBFD configuration, and may communicate on an uplink sub-band and/or a downlink sub-band of an SBFD resource. It should be noted that a UE 120 with a capability for SBFD operation may communicate in half-duplex or in full-duplex. A UE 120 that does not have a capability for SBFD operation may be referred to as a non-SBFD-aware UE.

Reference number 615 shows an SBFD slot configured in a flexible slot (e.g., a legacy flexible slot, as indicated by a TDD configuration). For example, the flexible slot may be configured to include an uplink sub-band for SBFD operation. Reference number 620 shows an SBFD slot configured in a downlink slot. For example, the downlink slot (e.g., legacy downlink slot, as indicated by a TDD configuration) may be configured to include an uplink sub-band for SBFD operation.

As shown, in some examples, an RO 625 may be configured in an uplink sub-band of a flexible slot configured for SBFD operation. This RO 625 may be valid for SBFD-aware UEs and non-SBFD-aware UEs. For example, a network node 110 may be allowed to configure ROs in flexible symbols with uplink sub-bands for SBFD operation. As further shown, in some examples, an RO 630 may be configured in an uplink slot (e.g., a legacy uplink slot as indicated by a TDD configuration). This RO 630 may be valid for SBFD-aware UEs and non-SBFD-aware UEs.

As shown, in some examples, an RO 635 may be configured in an uplink sub-band of a downlink slot configured for SBFD operation. In some examples (shown as “Example 1”), an RO 635 configured in an uplink sub-band of a downlink slot may be valid for SBFD-aware UEs. For example, a wireless communication standard and/or governing body may provide a rule indicating that ROs configured in downlink symbols with an uplink sub-band for SBFD operation are valid for SBFD-aware UEs.

In some examples (shown as “Example 2”), an RO 635 configured in an uplink sub-band of a downlink slot may be invalid for SBFD-aware UEs. For example, a wireless communication standard and/or governing body may provide a rule indicating that ROs configured in downlink symbols with an uplink sub-band for SBFD operation are not valid for SBFD-aware UEs, or may not provide a rule indicating that ROs configured in downlink symbols with an uplink sub-band for SBFD operation are valid for SBFD-aware UEs. Thus, an SBFD-aware UE (e.g., UE 120 with a capability for SBFD operation) may identify an RO 635 configured in an uplink sub-band of a downlink slot as invalid.

In some examples (shown as “Example 3”), an RO 635 may not be permitted to be configured in an uplink sub-band of a downlink slot configured for SBFD operation. For example, a wireless communication standard and/or governing body may provide a rule indicating that a network node 110 can configure ROs in flexible symbols with uplink sub-bands for SBFD operation, and that the network node 110 is not allowed to configure ROs in downlink symbols with uplink sub-bands for SBFD operation. The network node 110, when transmitting an SBFD configuration, may transmit the SBFD configuration in accordance with the rule.

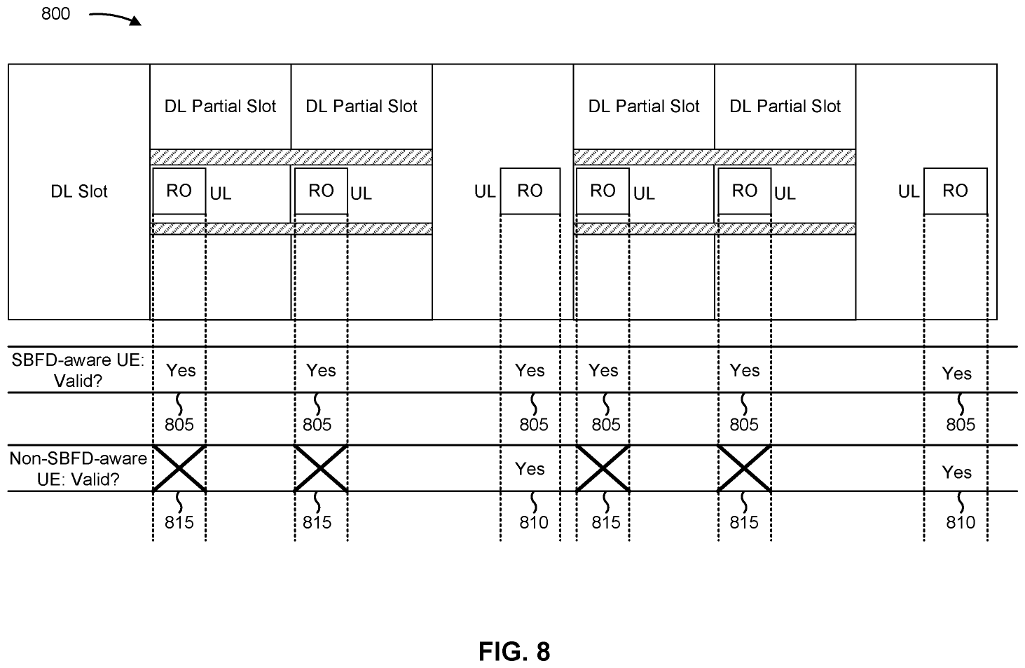

Additional description of validity of ROs, for SBFD-aware UEs and non-SBFD-aware UEs, is provided in connection with FIGS. 8-12.

As indicated above, FIG. 6 is provided as an example. Other examples may differ from what is described with regard to FIG. 6.

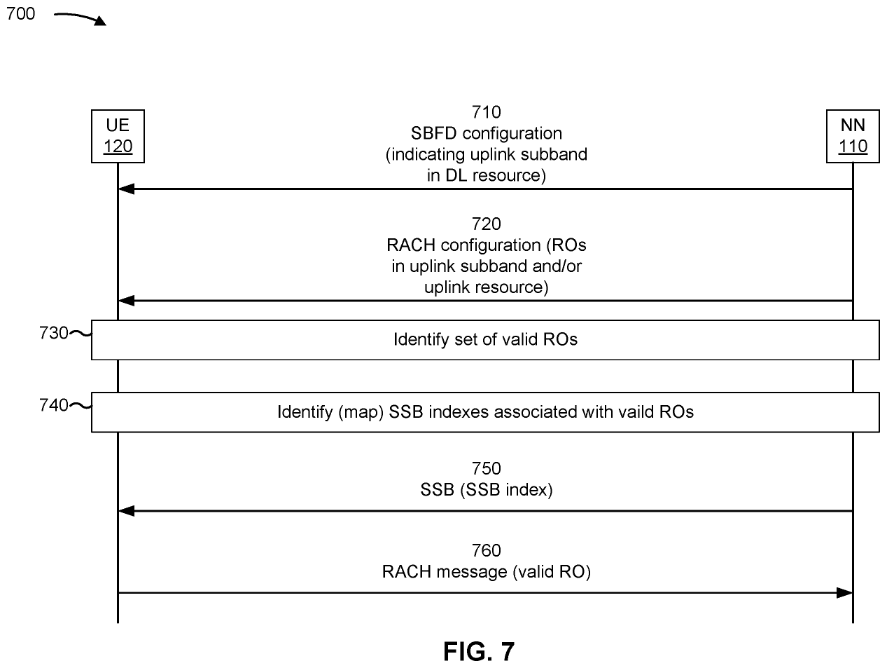

FIG. 7 is a diagram illustrating an example 700 of signaling associated with RACH configuration for SBFD, in accordance with the present disclosure. Example 700 includes a UE 120 and a network node 110. In some aspects, the UE 120 may be in a connected mode (e.g., connected state) with the network node 110, such as an RRC connected state. In some other aspects, the UE 120 may be in an idle or inactive mode (e.g., idle/inactive state) with the network node 110, such as an RRC idle or inactive state.

As shown by reference number 710, the network node 110 may transmit, and the UE 120 may receive, an SBFD configuration. For example, the network node 110 may transmit the SBFD configuration via system information, RRC signaling, MAC signaling, DCI, or the like. The SBFD configuration may indicate one or more symbols as SBFD symbols. For example, the SBFD configuration may indicate a flexible symbol as having an uplink sub-band. As another example, the SBFD configuration may indicate a downlink symbol as having an uplink sub-band.

As shown by reference number 720, the network node 110 may transmit, and the UE 120 may receive, a RACH configuration. The RACH configuration is described in more detail in connection with FIG. 6. The RACH configuration may indicate a plurality of ROs. In some aspects, the network node 110 may transmit a same RACH configuration for SBFD symbols and for non-SBFD symbols. For example, the network node 110 may configure a RACH configuration that is applicable for SBFD-aware UEs (e.g., UEs having a capability for SBFD operation) and non-SBFD-aware UEs (e.g., UEs not having a capability for SBFD operation). Configuring a same RACH configuration for SBFD symbols and non-SBFD symbols may increase the number of ROs configured in SBFD symbols, which improves reliability. Furthermore, the same RACH configuration may enable RO repetition, which improves coverage and RACH capacity. In some other aspects, the network node 110 may configure a first RACH configuration for SBFD symbols and a second RACH configuration for non-SBFD symbols. For example, the first RACH configuration may be directed to or readable by SBFD-aware UEs and the second RACH configuration may be directed to or readable by non-SBFD-aware UEs (and SBFD-aware UEs, in some examples). As another example, the first RACH configuration may indicate ROs on SBFD symbols (e.g., only on SBFD symbols, such as in uplink sub-bands of SBFD symbols) and the second RACH configuration may indicate ROs on uplink symbols (e.g., legacy uplink symbols, uplink symbols configured via a TDD configuration). Configuring separate RACH configurations may improve RACH capacity, enable longer PRACH sequences with back-to-back RACH RO slots in uplink sub-bands of SBFD slots, and improve reliability.

In some aspects, the network node 110 may configure separate RACH configurations for different UEs 120, as mentioned. For example, for a connected state UE 120, the network node 110 may configure a UE-specific RACH configuration (e.g., indicating one or more beam failure recovery ROs) or a cell-common RACH configuration (e.g., indicating one or more mobility ROs). As another example, for an idle-mode UE, the network node 110 may configure a cell-common RACH configuration via system information signaling (such as a SIB).

The RACH configuration(s) may indicate a plurality of RACH occasions. In some aspects, a set of RACH occasions of the plurality of RACH occasions may occur in uplink symbols (e.g., as indicated by a TDD configuration). Additionally, or alternatively, a set of RACH occasions of the plurality of RACH occasions may occur in flexible symbols configured with an uplink sub-band for SBFD operation. Additionally, or alternatively, a set of RACH occasions of the plurality of RACH occasions may occur in downlink symbols configured with an uplink sub-band for SBFD operation. In some other aspects, as described elsewhere herein, the network node 110 may not be allowed to configure ROs in downlink symbols configured with an uplink sub-band for SBFD operation.

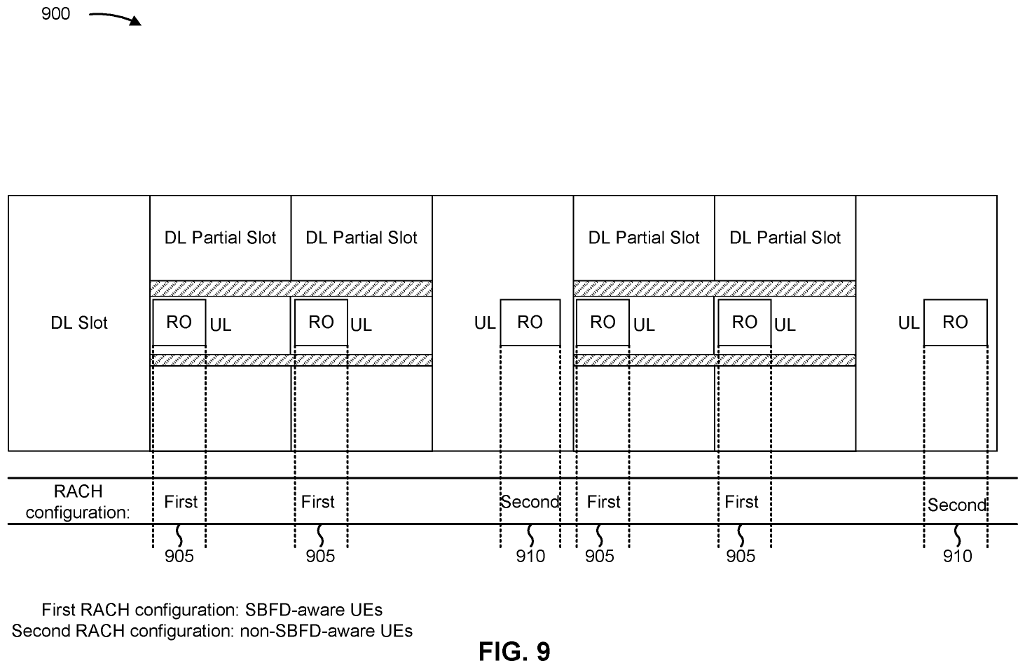

As shown by reference number 730, the UE 120 and/or the network node 110 may identify a set of valid ROs of the plurality of ROs. Thus, the UE 120 and the network node 110 may come to a mutual understanding of which ROs are valid. The identification of valid ROs is described in more detail in connection with FIG. 6. Additional description of identification of valid ROs is provided below in connection with FIGS. 8 and 9.

FIG. 8 is a diagram illustrating an example 800 of valid and invalid ROs for SBFD-aware UEs and non-SBFD-aware UEs, in accordance with the present disclosure. In example 800, a single RACH configuration may be used for SBFD symbols (e.g., SBFD-aware UEs) and non-SBFD symbols (e.g., non-SBFD-aware UEs). As another example, a single RACH configuration may be used for SBFD-aware UEs and non-SBFD-aware UEs. In some aspects, the single RACH configuration may identify ROs across SBFD symbols and non-SBFD symbols. As shown by reference number 805, ROs in downlink symbols with an uplink sub-band for SBFD operation, and ROs in uplink symbols, may be identified as valid by SBFD-aware UEs. Furthermore, as shown by reference number 810, ROs in uplink symbols may be identified as valid by non-SBFD-aware UEs. As shown by reference number 815, ROs in downlink symbols with an uplink sub-band for SBFD operation may be identified as invalid by non-SBFD-aware UEs.

FIG. 9 is a diagram illustrating an example 900 of ROs configured by a first RACH configuration and a second RACH configuration, in accordance with the present disclosure. For example, the first RACH configuration may be for SBFD symbols (e.g., SBFD-aware UEs) and the second RACH configuration may be for non-SBFD symbols (e.g., non-SBFD-aware UEs and optionally SBFD-aware UEs). As another example, the first RACH configuration may be for SBFD-aware UEs and the second RACH configuration may be for non-SBFD-aware UEs. As shown by reference number 905, the first RACH configuration may indicate a set of ROs in downlink symbols with uplink sub-bands for SBFD operation. As shown by reference number 910, the second RACH configuration may indicate a set of ROs in uplink symbols.

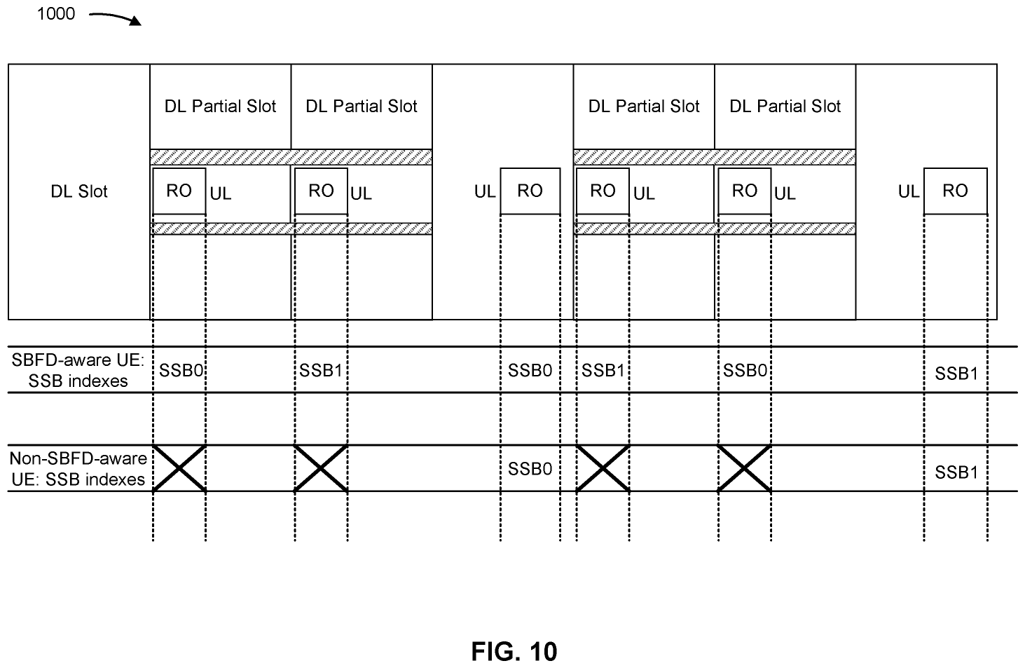

Returning to FIG. 7, as shown by reference number 740, the UE 120 and/or the network node 110 may identify SSB indexes associated with valid RACH occasions (referred to herein as mapping SSB indexes to ROs). Thus, the UE 120 and the network node 110 may come to a mutual understanding of mappings of SSB indexes to ROs. For example, the UE 120 and the network node 110 may perform SSB-to-RO mapping. Notably, the UE 120 may perform the SSB-to-RO mapping after identifying valid ROs, such that SSB indexes are not identified for invalid ROs. The UE 120 may perform the mapping according to one or more parameters. For example, the UE 120 may perform the mapping according to a parameter that indicates how many SSB indexes are mapped to one RO. As another example, the UE 120 may perform the mapping according to a parameter that indicates a number of preambles per SSB. Description of identification of SSB indexes associated with valid RACH occasions is provided below in connection with FIGS. 10-12.

FIG. 10 is a diagram illustrating an example 1000 of mapping of SSB indexes after valid RO identification, in accordance with the present disclosure. As described in connection with FIG. 8, in example 1000, ROs included in uplink symbols are valid for both SBFD-aware UEs and non-SBFD-aware UEs, and ROs included in downlink symbols with uplink sub-bands configured for SBFD operation are valid only for SBFD-aware UEs. Example 1000 may relate to a case where a same RACH configuration is used for SBFD-aware UEs and non-SBFD-aware UEs. As shown, a UE 120 may map SSB indexes to valid ROs. Thus, the SBFD-aware UE may map alternating SSB indexes (SSB0 and SSB1) to valid ROs across the SBFD symbols and the non-SBFD symbols. Furthermore, the non-SBFD-aware UEs may map alternating SSB indexes (SSB0 and SSB1) to valid ROs on the uplink symbols.

In some aspects, the network node 110 may configure ROs such that ROs in uplink symbols (e.g., legacy uplink symbols) are identified (e.g., mapped) with the same SSB indexes for both SBFD-aware UEs and non-SBFD-aware UEs. For example, a wireless communication standard and/or governing body may mandate that the ROs in uplink symbols be configured such that the ROs are mapped to the same SSB indexes Example 1000 is an example of a configuration in which the ROs in the uplink symbols have the same mapping.

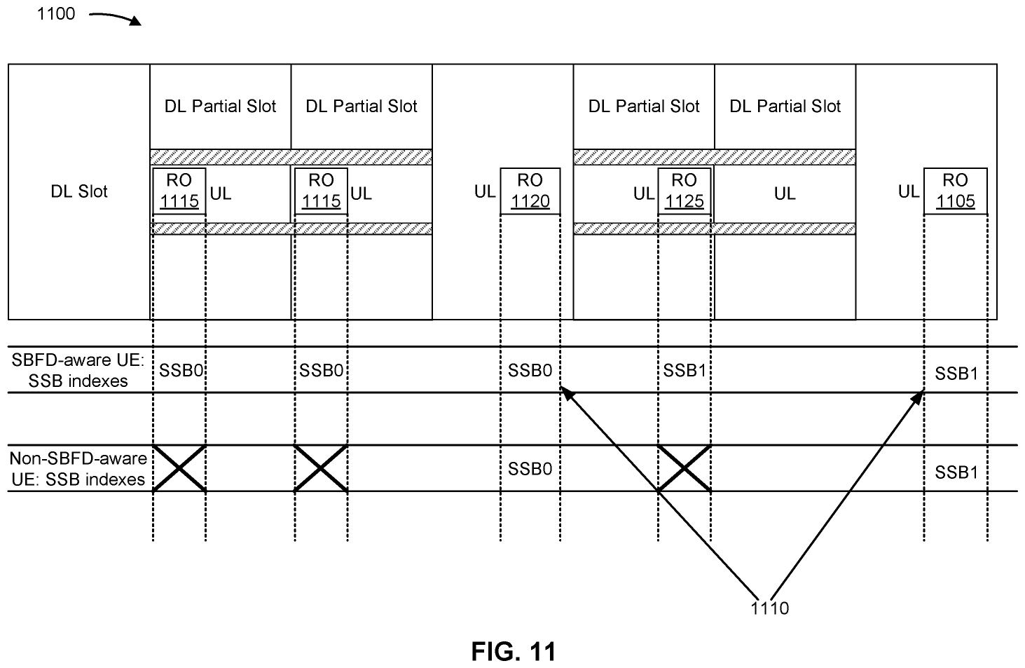

However, there are other examples where ROs in uplink symbols may not be mapped to the same SSB indexes by SBFD-aware UEs and non-SBFD-aware UEs, if SSB indexes are mapped/assigned in order of time occurrence of the corresponding ROs. FIG. 11 is a diagram illustrating example 1100 of mapping of SSB indexes after valid RO identification, in accordance with the present disclosure. Example 1100 relates to a case where a same RACH configuration is used for SBFD-aware and non-SBFD-aware UEs. If SSB indexes are mapped in order of time occurrence of ROs by the SBFD-aware UE and the non-SBFD-aware UE, then the RO 1105 may have a different SSB index for the SBFD-aware UE and the non-SBFD-aware UE. This is not illustrated in FIG. 11, since FIG. 11 provides a technique for mapping SSB indexes that avoids a mismatch between SSB indexes for SBFD-aware UEs and non-SBFD-aware UEs.

In some aspects, a UE (e.g., an SBFD-aware UE) may first identify SSB indexes for ROs in uplink symbols (e.g., legacy uplink symbols). This is illustrated by reference number 1110. As shown, the SSB indexes of the ROs in the uplink symbols are the same for the SBFD-aware UE and the non-SBFD-aware UE. The UE (e.g., the SBFD-aware UE) may then identify SSB indexes for ROs in downlink symbols with uplink sub-bands for SBFD operation. For example, the UE may apply a mapping rule to identify the SSB indexes for the ROs in the downlink symbols.

In some aspects, the mapping rule may indicate that a same SSB index is identified for the ROs in the downlink symbols as was identified for a next RO in an uplink symbol. This is illustrated in example 1100. For example, the ROs 1115 are mapped to SSB0 in accordance with the RO 1120 being mapped to SSB0, and the RO 1125 is mapped to SSB1 in accordance with the RO 1105 being mapped to SSB1. This may provide RO repetition, thereby enhancing coverage. In some aspects, the mapping rule may indicate that a same SSB index is identified for the ROs in the downlink symbols as was identified for a previous (e.g., immediately previous) RO in an uplink symbol. If this mapping rule was used, then the RO 1125 may be mapped to SSB0. Thus, the UE 120 may identify a same SSB index for ROs on SBFD symbols as a given SSB index of a nearest preceding (earlier) RO on an uplink signal. Alternatively, the UE 120 may identify a same SSB index for ROs on SBFD symbols as a given SSB index of a nearest following (later) RO on an uplink symbol.

In some aspects, a mapping sequence may be used. A mapping sequence may indicate a sequence of SSB indexes to be applied to ROs in downlink symbols with uplink sub-bands for SBFD operation. The UE (e.g., SBFD-aware UE) may identify SSB indexes for the ROs according to the mapping sequence while skipping ROs in uplink symbols. An example mapping sequence that would provide the same SSB-to-RO mapping of example 1100 is [SSB0 SSB0 SSB1].

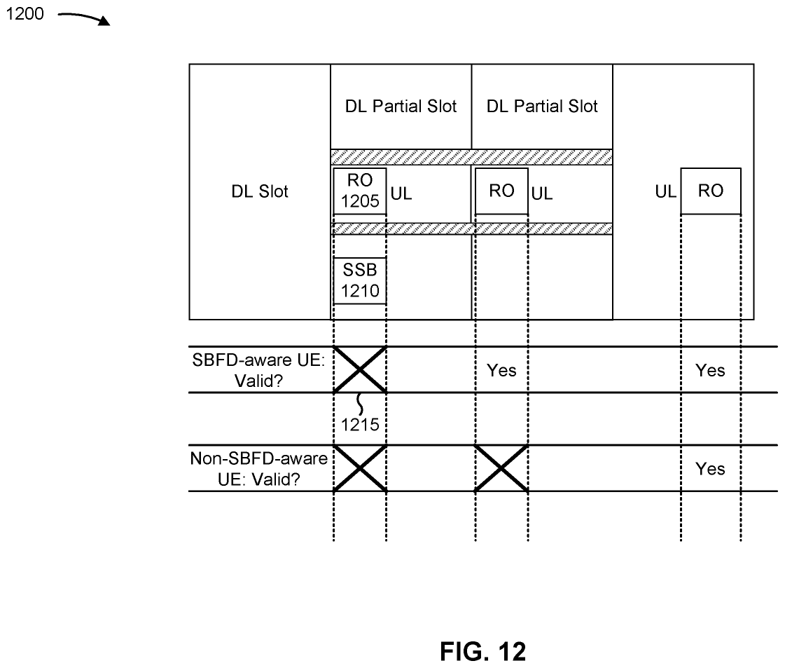

FIG. 12 is a diagram illustrating an example 1200 of invalidating an RO based on a conflict with an SSB, in accordance with the present disclosure. In example 1200, an RO 1205 is configured in a downlink symbol with an uplink sub-band for SBFD operation. An SSB 1210 is configured in the downlink symbol. For example, the SSB 1210 may overlap the RO 1205 in time (though in some aspects, the SSB 1210 may not overlap the RO 1205 in time). As shown by reference number 1215, the SBFD-aware UE may identify the RO 1205 as invalid. Thus, reception (e.g., measurement) of the SSB 1210 is protected. In some examples, example 1200 may relate to a case where a same RACH configuration is provided for SBFD symbols and non-SBFD symbols.

In some aspects, as mentioned, the network node 110 may provide a first RACH configuration for SBFD symbols (e.g., SBFD-aware UEs) and a second RACH configuration for non-SBFD symbols (e.g., non-SBFD-aware UEs and optionally SBFD-aware UEs). In some aspects, an RO, configured by the first RACH configuration, that occurs in a non-SBFD symbol (e.g., an uplink symbol such as a legacy uplink symbol), may be identified as invalid by an SBFD-aware UE. Thus, conflict with ROs for non-SBFD-aware UEs is avoided. In cases with a first RACH configuration and a second RACH configuration, SSB-to-RO mapping may be performed separately for each RACH configuration. Alternatively, an SBFD-aware UE may perform a combined SSB-to-RO mapping across the first RACH configuration and the second RACH configuration (such as using techniques described with regard to FIGS. 10 and/or 11).

As shown by reference number 750, the network node 110 may transmit, and the UE 120 may receive, an SSB associated with an SSB index. The SSB index may be an SSB index that was mapped to an RO by the UE 120 and/or the network node 110. As shown by reference number 760, the UE 120 may transmit, and the network node 110 may receive, a RACH message on a valid RACH occasion, of the set of valid RACH occasions. For example, the valid RACH occasion may correspond to (be mapped to or identified with) the SSB index of the received SSB.

As indicated above, FIGS. 7-12 are provided as examples. Other examples may differ from what is described with regard to FIGS. 7-12.

FIG. 13 is a diagram illustrating an example process 1300 performed, for example, at a UE or an apparatus of a UE, in accordance with the present disclosure. Example process 1300 is an example where the apparatus or the UE (e.g., UE 120) performs operations associated with techniques for random access in sub-band full duplex symbol.

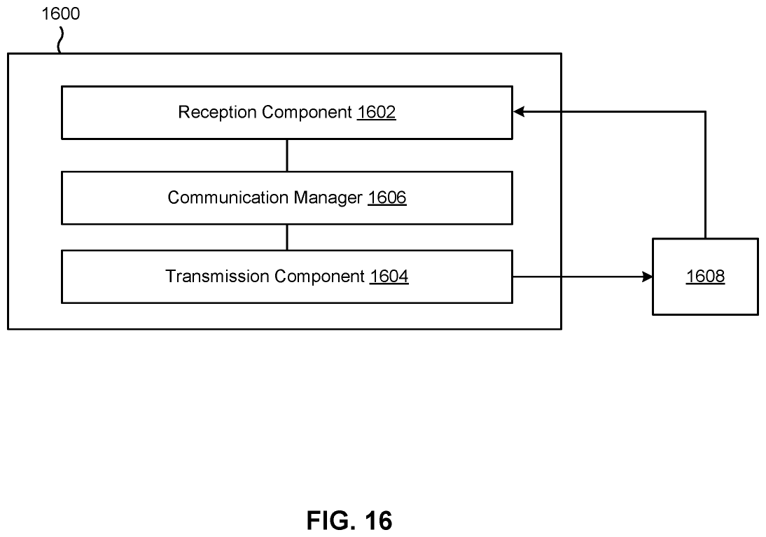

As shown in FIG. 13, in some aspects, process 1300 may include receiving an SBFD configuration that indicates an uplink sub-band in a downlink symbol (block 1310). For example, the apparatus or the UE (e.g., using reception component 1602 and/or communication manager 1606, depicted in FIG. 16) may receive an SBFD configuration that indicates an uplink sub-band in a downlink symbol, as described above.

As further shown in FIG. 13, in some aspects, process 1300 may include receiving a RACH configuration, wherein the RACH configuration indicates a plurality of RACH occasions (block 1320). For example, the apparatus or the UE (e.g., using reception component 1602 and/or communication manager 1606, depicted in FIG. 16) may receive a RACH configuration, wherein the RACH configuration indicates a plurality of RACH occasions, as described above.

As further shown in FIG. 13, in some aspects, process 1300 may include identifying a set of valid RACH occasions of the plurality of RACH occasions, wherein the set of valid RACH occasions includes one or more first valid RACH occasions on one or more uplink symbols and one or more second valid RACH occasions on the uplink sub-band in the downlink symbol (block 1330). For example, the apparatus or the UE (e.g., using communication manager 1606, depicted in FIG. 16) may identify a set of valid RACH occasions of the plurality of RACH occasions, wherein the set of valid RACH occasions includes one or more first valid RACH occasions on one or more uplink symbols and one or more second valid RACH occasions on the uplink sub-band in the downlink symbol, as described above.

As further shown in FIG. 13, in some aspects, process 1300 may include identifying a first set of SSB indexes associated with the one or more first valid RACH occasions (block 1340). For example, the apparatus or the UE (e.g., using communication manager 1606, depicted in FIG. 16) may identify a first set of SSB indexes associated with the one or more first valid RACH occasions, as described above.

As further shown in FIG. 13, in some aspects, process 1300 may include identifying, after identifying the first set of SSB indexes, a second set of SSB indexes associated with the one or more second valid RACH occasions (block 1350). For example, the apparatus or the UE (e.g., using communication manager 1606, depicted in FIG. 16) may identify, after identifying the first set of SSB indexes, a second set of SSB indexes associated with the one or more second valid RACH occasions, as described above.

As further shown in FIG. 13, in some aspects, process 1300 may optionally include receiving an SSB associated with an SSB index of the first set of SSB indexes or the second set of SSB indexes (block 1360). For example, the apparatus or the UE (e.g., using reception component 1602 and/or communication manager 1606, depicted in FIG. 16) may receive an SSB associated with an SSB index of the first set of SSB indexes or the second set of SSB indexes, as described above.

As further shown in FIG. 13, in some aspects, process 1300 may include transmitting a RACH message on a valid RACH occasion of the set of valid RACH occasions, the valid RACH occasion being associated with an SSB index of the first set of SSB indexes or the second set of SSB indexes (block 1370). For example, the apparatus or the UE (e.g., using transmission component 1604 and/or communication manager 1606, depicted in FIG. 16) may transmit a RACH message on a valid RACH occasion of the set of valid RACH occasions. In some aspects, the valid RACH occasion may be associated with an SSB index of the first set of SSB indexes or the second set of SSB indexes (such as the SSB index of the received SSB).

Process 1300 may include additional aspects, such as any single aspect or any combination of aspects described below and/or in connection with one or more other processes described elsewhere herein.

In a first aspect, identifying the second set of SSB indexes further comprises identifying the second set of SSB indexes associated with the one or more second valid RACH occasions in the uplink sub-band in accordance with an SBFD-aware status of the UE.

In a second aspect, alone or in combination with the first aspect, identifying the second set of SSB indexes further comprises identifying an SSB index, of the second set of SSB indexes, as associated with the one or more second valid RACH occasions in the uplink sub-band in accordance with a nearest SSB index on the one or more uplink symbols.

In a third aspect, alone or in combination with one or more of the first and second aspects, identifying the second set of SSB indexes further comprises identifying an SSB index, of the second set of SSB indexes, as associated with the one or more second valid RACH occasions in the uplink sub-band in accordance with a mapping sequence that skips the one or more uplink symbols.

In a fourth aspect, alone or in combination with one or more of the first through third aspects, identifying the set of valid RACH occasions further comprises identifying a RACH occasion in the uplink sub-band as invalid in accordance with a synchronization signal block overlapping the RACH occasion in time.

In a fifth aspect, alone or in combination with one or more of the first through fourth aspects, the RACH configuration is specific to SBFD symbols, wherein identifying the set of valid RACH occasions further comprises identifying a RACH occasion, in an uplink symbol, as invalid in accordance with the UE being an SBFD-aware UE.

In a sixth aspect, alone or in combination with one or more of the first through fifth aspects, the UE is in a connected state, and the RACH configuration comprises at least one of a UE-specific RACH configuration, or a cell-common RACH configuration.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, at a network node or an apparatus of a network node, in accordance with the present disclosure. Example process 1400 is an example where the apparatus or the network node (e.g., network node 110) performs operations associated with techniques for random access in sub-band full duplex symbols.

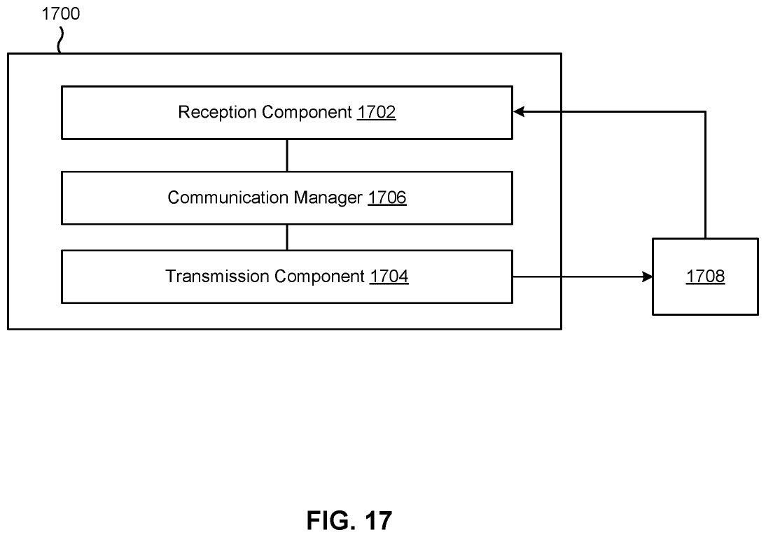

As shown in FIG. 14, in some aspects, process 1400 may include transmitting an SBFD configuration that indicates an uplink sub-band in a downlink symbol (block 1410). For example, the network node (e.g., using transmission component 1704 and/or communication manager 1706, depicted in FIG. 17) may transmit an SBFD configuration that indicates an uplink sub-band in a downlink symbol, as described above.

As further shown in FIG. 14, in some aspects, process 1400 may include transmitting a RACH configuration, wherein the RACH configuration indicates a plurality of RACH occasions (block 1420). For example, the network node (e.g., using transmission component 1704 and/or communication manager 1706, depicted in FIG. 17) may transmit a RACH configuration, wherein the RACH configuration indicates a plurality of RACH occasions, as described above.

As further shown in FIG. 14, in some aspects, process 1400 may include identifying a set of valid RACH occasions of the plurality of RACH occasions (block 1430). For example, the network node (e.g., using communication manager 1706, depicted in FIG. 17) may identify a set of valid RACH occasions of the plurality of RACH occasions, as described above.

As further shown in FIG. 14, in some aspects, process 1400 may include identifying one or more sets of SSB indexes associated with the set of valid RACH occasions (block 1440). For example, the network node (e.g., using communication manager 1706, depicted in FIG. 17) may identify one or more sets of SSB indexes associated with the set of valid RACH occasions, as described above.

As further shown in FIG. 14, in some aspects, process 1400 may optionally include transmitting an SSB associated with an SSB index of the one or more sets of SSB indexes (block 1450). For example, the network node (e.g., using transmission component 1704 and/or communication manager 1706, depicted in FIG. 17) may transmit an SSB associated with an SSB index of the one or more sets of SSB indexes, as described above.

As further shown in FIG. 14, in some aspects, process 1400 may include monitoring for a RACH message on a valid RACH occasion of the set of valid RACH occasions, the valid RACH occasion corresponding to the SSB index (block 1460). For example, the network node (e.g., using communication manager 1706, depicted in FIG. 17) may monitor for a RACH message on a valid RACH occasion of the set of valid RACH occasions, the valid RACH occasion being associated with (e.g., corresponding to) an SSB index of the one or more sets of SSB indexes, as described above.

Process 1400 may include additional aspects, such as any single aspect or any combination of aspects described below and/or in connection with one or more other processes described elsewhere herein.

In a first aspect, the plurality of RACH occasions includes at least one RACH occasion in the uplink sub-band.

In a second aspect, alone or in combination with the first aspect, the at least one RACH occasion is invalid for an SBFD-aware UE.

In a third aspect, alone or in combination with one or more of the first and second aspects, transmitting the RACH configuration further comprises transmitting the RACH configuration in accordance with a rule indicating that the network node is not allowed to configure RACH occasions in the uplink sub-band in the downlink symbol.

In a fourth aspect, alone or in combination with one or more of the first through third aspects, the RACH configuration comprises a single RACH configuration for an SBFD-aware UE and a non-SBFD-aware UE.

In a fifth aspect, alone or in combination with one or more of the first through fourth aspects, for the first UE, the set of valid RACH occasions includes at least one RACH occasion in the uplink sub-band of the downlink symbol and, for the second UE, the set of valid RACH occasions includes no RACH occasion in the uplink sub-band of the downlink symbol.

In a sixth aspect, alone or in combination with one or more of the first through fifth aspects, the RACH configuration is configured such that SSB indexes, mapped to RACH occasions valid for the first UE, are aligned with SSB indexes mapped to RACH occasions valid for the second UE.

In a seventh aspect, alone or in combination with one or more of the first through sixth aspects, the RACH configuration comprises a first RACH configuration indicating one or more first RACH occasions for SBFD symbols and a second RACH configuration indicating one or more second RACH occasions for non-SBFD symbols.

In an eighth aspect, alone or in combination with one or more of the first through seventh aspects, a first RACH occasion, of the one or more first RACH occasions, that occurs in an uplink symbol, is invalid.

In a ninth aspect, alone or in combination with one or more of the first through eighth aspects, transmitting the RACH configuration further comprises transmitting the RACH configuration via at least one of a UE-specific RACH configuration, or a cell-common RACH configuration.

In a tenth aspect, alone or in combination with one or more of the first through ninth aspects, transmitting the RACH configuration further comprises transmitting the first RACH configuration via first cell-common signaling and the second RACH configuration via second cell-common signaling.

In an eleventh aspect, alone or in combination with one or more of the first through tenth aspects, identifying the one or more sets of SSB indexes associated with the set of valid RACH occasions further comprises identifying a first set of SSB indexes associated with the one or more second RACH occasions, and identifying, after the first set of SSB indexes, a second set of SSB indexes associated with the one or more first RACH occasions.

In a twelfth aspect, alone or in combination with one or more of the first through eleventh aspects, identifying the one or more sets of SSB indexes associated with the set of valid RACH occasions further comprises identifying an SSB index, of a set of SSB indexes associated with SBFD symbols, associated with at least one RACH occasion in the uplink sub-band in accordance with a nearest SSB index on one or more uplink symbols.

In a thirteenth aspect, alone or in combination with one or more of the first through twelfth aspects, identifying the one or more sets of SSB indexes associated with the set of valid RACH occasions further comprises identifying an SSB index, of a set of SSB indexes associated with SBFD symbols, associated with at least one RACH occasion in the uplink sub-band in accordance with a mapping sequence that skips one or more uplink symbols.

In a fourteenth aspect, alone or in combination with one or more of the first through thirteenth aspects, identifying the set of valid RACH occasions further comprises identifying a RACH occasion in the uplink sub-band as invalid in accordance with a synchronization signal block overlapping the RACH occasion in time.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

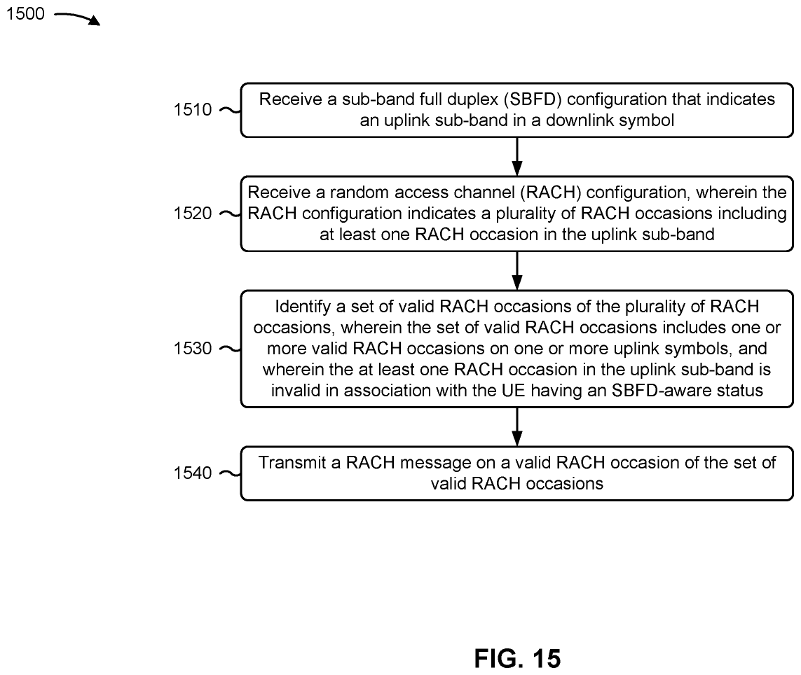

FIG. 15 is a diagram illustrating an example process 1500 performed, for example, at a UE or an apparatus of a UE, in accordance with the present disclosure. Example process 1500 is an example where the apparatus or the UE (e.g., UE 120) performs operations associated with brief description of the drawings.

As shown in FIG. 15, in some aspects, process 1500 may include receiving a sub-band full duplex (SBFD) configuration that indicates an uplink sub-band in a downlink symbol (block 1510). For example, the apparatus or the UE (e.g., using reception component 1602 and/or communication manager 1606, depicted in FIG. 16) may receive a sub-band full duplex (SBFD) configuration that indicates an uplink sub-band in a downlink symbol, as described above.

As further shown in FIG. 15, in some aspects, process 1500 may include receiving a random access channel (RACH) configuration, wherein the RACH configuration indicates a plurality of RACH occasions including at least one RACH occasion in the uplink sub-band (block 1520). For example, the apparatus or the UE (e.g., using reception component 1602 and/or communication manager 1606, depicted in FIG. 16) may receive a random access channel (RACH) configuration, wherein the RACH configuration indicates a plurality of RACH occasions including at least one RACH occasion in the uplink sub-band, as described above.

As further shown in FIG. 15, in some aspects, process 1500 may include identifying a set of valid RACH occasions of the plurality of RACH occasions, wherein the set of valid RACH occasions includes one or more valid RACH occasions on one or more uplink symbols, and wherein the at least one RACH occasion in the uplink sub-band is invalid for the UE having an SBFD-aware status (block 1530). For example, the apparatus or the UE (e.g., using communication manager 1606, depicted in FIG. 16) may identify a set of valid RACH occasions of the plurality of RACH occasions, wherein the set of valid RACH occasions includes one or more valid RACH occasions on one or more uplink symbols, and wherein the at least one RACH occasion in the uplink sub-band is invalid for the UE having an SBFD-aware status, as described above.

As further shown in FIG. 15, in some aspects, process 1500 may include transmitting a RACH message on a valid RACH occasion of the set of valid RACH occasions (block 1540). For example, the apparatus or the UE (e.g., using transmission component 1604 and/or communication manager 1606, depicted in FIG. 16) may transmit a RACH message on a valid RACH occasion of the set of valid RACH occasions, as described above.

Process 1500 may include additional aspects, such as any single aspect or any combination of aspects described below and/or in connection with one or more other processes described elsewhere herein.

In a first aspect, the RACH configuration comprises a single RACH configuration for SBFD symbols and non-SBFD symbols.

In a second aspect, alone or in combination with the first aspect, identifying the set of valid RACH occasions further comprises identifying the at least one RACH occasion in the uplink sub-band as invalid in association with the UE having the SBFD-aware status.

In a third aspect, alone or in combination with one or more of the first and second aspects, receiving the RACH configuration further comprises receiving the RACH configuration via at least one of a UE-specific RACH configuration, or a cell-common RACH configuration.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram of an example apparatus 1600 for wireless communication, in accordance with the present disclosure. The apparatus 1600 may be a UE, or a UE may include the apparatus 1600. In some aspects, the apparatus 1600 includes a reception component 1602, a transmission component 1604, and/or a communication manager 1606, which may be in communication with one another (for example, via one or more buses and/or one or more other components). In some aspects, the communication manager 1606 is the communication manager 140 described in connection with FIG. 1. As shown, the apparatus 1600 may communicate with another apparatus 1608, such as a UE or a network node (such as a CU, a DU, an RU, or a base station), using the reception component 1602 and the transmission component 1604.

In some aspects, the apparatus 1600 may be configured to perform one or more operations described herein in connection with FIGS. 5-12. Additionally, or alternatively, the apparatus 1600 may be configured to perform one or more processes described herein, such as process 1300 of FIG. 13, process 1500 of FIG. 15, or a combination thereof. In some aspects, the apparatus 1600 and/or one or more components shown in FIG. 16 may include one or more components of the UE described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1608. In some aspects, the transmission component 1604 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1604 may be co-located with the reception component 1602 in one or more transceivers.

The communication manager 1606 may support operations of the reception component 1602 and/or the transmission component 1604. For example, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

The reception component 1602 may receive an SBFD configuration that indicates an uplink sub-band in a downlink symbol. The reception component 1602 may receive a RACH configuration, wherein the RACH configuration indicates a plurality of RACH occasions. The communication manager 1606 may identify a set of valid RACH occasions of the plurality of RACH occasions, wherein the set of valid RACH occasions includes one or more first valid RACH occasions on one or more uplink symbols and one or more second valid RACH occasions on the uplink sub-band in the downlink symbol. The communication manager 1606 may identify a first set of SSB indexes associated with the one or more first valid RACH occasions. The communication manager 1606 may identify, after identifying the first set of SSB indexes, a second set of SSB indexes associated with the one or more second valid RACH occasions. The reception component 1602 may receive an SSB associated with an SSB index of the first set of SSB indexes or the second set of SSB indexes. The transmission component 1604 may transmit a RACH message on a valid RACH occasion of the set of valid RACH occasions, the valid RACH occasion corresponding to the SSB index.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

FIG. 17 is a diagram of an example apparatus 1700 for wireless communication, in accordance with the present disclosure. The apparatus 1700 may be a network node, or a network node may include the apparatus 1700. In some aspects, the apparatus 1700 includes a reception component 1702, a transmission component 1704, and/or a communication manager 1706, which may be in communication with one another (for example, via one or more buses and/or one or more other components). In some aspects, the communication manager 1706 is the communication manager 150 described in connection with FIG. 1. As shown, the apparatus 1700 may communicate with another apparatus 1708, such as a UE or a network node (such as a CU, a DU, an RU, or a base station), using the reception component 1702 and the transmission component 1704.

In some aspects, the apparatus 1700 may be configured to perform one or more operations described herein in connection with FIGS. 5-12. Additionally, or alternatively, the apparatus 1700 may be configured to perform one or more processes described herein, such as process 1400 of FIG. 14, or a combination thereof. In some aspects, the apparatus 1700 and/or one or more components shown in FIG. 17 may include one or more components of the network node described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1702 may receive communications, such as reference signals, control information, data communications, or a combination thereof, from the apparatus 1708. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1702 and/or the transmission component 1704 may include or may be included in a network interface. The network interface may be configured to obtain and/or output signals for the apparatus 1700 via one or more communications links, such as a backhaul link, a midhaul link, and/or a fronthaul link.

The transmission component 1704 may transmit communications, such as reference signals, control information, data communications, or a combination thereof, to the apparatus 1708. In some aspects, one or more other components of the apparatus 1700 may generate communications and may provide the generated communications to the transmission component 1704 for transmission to the apparatus 1708. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1708. In some aspects, the transmission component 1704 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1704 may be co-located with the reception component 1702 in one or more transceivers.

The communication manager 1706 may support operations of the reception component 1702 and/or the transmission component 1704. For example, the communication manager 1706 may receive information associated with configuring reception of communications by the reception component 1702 and/or transmission of communications by the transmission component 1704. Additionally, or alternatively, the communication manager 1706 may generate and/or provide control information to the reception component 1702 and/or the transmission component 1704 to control reception and/or transmission of communications.

The transmission component 1704 may transmit an SBFD configuration that indicates an uplink sub-band in a downlink symbol. The transmission component 1704 may transmit a RACH configuration, wherein the RACH configuration indicates a plurality of RACH occasions. The communication manager 1706 may identify a set of valid RACH occasions of the plurality of RACH occasions. The communication manager 1706 may identify one or more sets of SSB indexes associated with the set of valid RACH occasions. The transmission component 1704 may transmit an SSB associated with an SSB index of the one or more sets of SSB indexes. The communication manager 1706 may monitor for a RACH message on a valid RACH occasion of the set of valid RACH occasions, the valid RACH occasion corresponding to the SSB index.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

The following provides an overview of some Aspects of the present disclosure:

Aspect 1: A method of wireless communication performed by a user equipment (UE), comprising: receiving a sub-band full duplex (SBFD) configuration that indicates an uplink sub-band in a downlink symbol; receiving a random access channel (RACH) configuration, wherein the RACH configuration indicates a plurality of RACH occasions; identifying a set of valid RACH occasions of the plurality of RACH occasions, wherein the set of valid RACH occasions includes one or more first valid RACH occasions on one or more uplink symbols and one or more second valid RACH occasions on the uplink sub-band in the downlink symbol; identifying a first set of synchronization signal block (SSB) indexes associated with the one or more first valid RACH occasions; identifying, after identifying the first set of SSB indexes, a second set of SSB indexes associated with the one or more second valid RACH occasions; transmitting a RACH message on a valid RACH occasion of the set of valid RACH occasions, the valid RACH occasion being associated with an SSB index of the first set of SSB indexes or the second set of SSB indexes.

Aspect 2: The method of Aspect 1, wherein identifying the second set of SSB indexes further comprises identifying the second set of SSB indexes associated with the one or more second valid RACH occasions in the uplink sub-band in accordance with an SBFD-aware status of the UE.

Aspect 3: The method of any of Aspects 1-2, wherein identifying the second set of SSB indexes further comprises identifying an SSB index, of the second set of SSB indexes, as associated with the one or more second valid RACH occasions in the uplink sub-band in accordance with a nearest SSB index on the one or more uplink symbols.

Aspect 4: The method of Aspect 3, wherein the nearest SSB index is an SSB index of a nearest preceding uplink symbol of the one or more uplink symbols.

Aspect 5: The method of Aspect 3, wherein the nearest SSB index is an SSB index of a nearest following uplink symbol of the one or more uplink symbols.

Aspect 6: The method of any of Aspects 1-5, wherein identifying the second set of SSB indexes further comprises identifying an SSB index, of the second set of SSB indexes, as associated with the one or more second valid RACH occasions in the uplink sub-band in accordance with a mapping sequence that skips the one or more uplink symbols.

Aspect 7: The method of any of Aspects 1-6, wherein identifying the set of valid RACH occasions further comprises identifying a RACH occasion in the uplink sub-band as invalid in accordance with a synchronization signal block overlapping the RACH occasion in time.

Aspect 8: The method of any of Aspects 1-7, wherein the UE is in a connected state, and wherein the RACH configuration comprises at least one of: a UE-specific RACH configuration, or a cell-common RACH configuration.

Aspect 9: A method of wireless communication performed by a network node, comprising: transmitting a sub-band full duplex (SBFD) configuration that indicates an uplink sub-band in a downlink symbol; transmitting a random access channel (RACH) configuration, wherein the RACH configuration indicates a plurality of RACH occasions; identifying a set of valid RACH occasions of the plurality of RACH occasions; identifying one or more sets of synchronization signal block (SSB) indexes associated with the set of valid RACH occasions; and monitoring for a RACH message on a valid RACH occasion of the set of valid RACH occasions, the valid RACH occasion being associated with an SSB index of the first set of SSB indexes or the second set of SSB indexes.

Aspect 10: The method of Aspect 9, wherein the plurality of RACH occasions includes at least one RACH occasion in the uplink sub-band.

Aspect 11: The method of Aspect 10, wherein the at least one RACH occasion in the uplink sub-band is invalid for a user equipment having an SBFD-aware status and a user equipment having a non-SBFD-aware status.

Aspect 12: The method of any of Aspects 9-11, wherein transmitting the RACH configuration further comprises transmitting the RACH configuration in accordance with a rule indicating that the network node is not allowed to configure RACH occasions in the uplink sub-band in the downlink symbol.

Aspect 13: The method of any of Aspects 9-12, wherein the RACH configuration comprises a single RACH configuration for a first user equipment (UE) having an SBFD-aware status and a second UE without the SBFD-aware status.

Aspect 14: The method of Aspect 13, wherein, for the first UE, the set of valid RACH occasions includes at least one RACH occasion in the uplink sub-band of the downlink symbol, and wherein, for the second UE, the set of valid RACH occasions includes no RACH occasion in the uplink sub-band of the downlink symbol.

Aspect 15: The method of Aspect 13, wherein the RACH configuration is configured such that SSB indexes, mapped to RACH occasions valid for the first UE, are aligned with SSB indexes mapped to RACH occasions valid for the second UE.

Aspect 16: The method of Aspect 13, wherein transmitting the RACH configuration further comprises transmitting the RACH configuration via at least one of: a UE-specific RACH configuration, or a cell-common RACH configuration.

Aspect 17: The method of any of Aspects 9-16, wherein the RACH configuration comprises a first RACH configuration indicating one or more first RACH occasions for SBFD symbols and a second RACH configuration indicating one or more second RACH occasions for non-SBFD symbols.

Aspect 18: The method of Aspect 17, wherein a first RACH occasion, of the one or more first RACH occasions, that occurs in an uplink symbol, is invalid for a user equipment having an SBFD-aware status.

Aspect 19: The method of Aspect 17, wherein transmitting the RACH configuration further comprises transmitting the first RACH configuration via first cell-common or UE specific signaling and the second RACH configuration via second cell-common or UE specific signaling.

Aspect 20: The method of Aspect 17, wherein identifying the one or more sets of SSB indexes associated with the set of valid RACH occasions further comprises: identifying a first set of SSB indexes associated with the one or more second RACH occasions; and identifying, after the first set of SSB indexes, a second set of SSB indexes associated with the one or more first RACH occasions.

Aspect 21: The method of any of Aspects 9-20, wherein identifying the one or more sets of SSB indexes associated with the set of valid RACH occasions further comprises identifying a particular SSB index, of a set of SSB indexes associated with SBFD symbols, associated with at least one RACH occasion in the uplink sub-band in accordance with a particular SSB index on one or more uplink symbols.

Aspect 22: The method of Aspect 21, wherein the particular SSB index is an SSB index of a nearest preceding uplink symbol.

Aspect 23: The method of Aspect 21, wherein the particular SSB index is an SSB index of a nearest following uplink symbol.

Aspect 24: The method of any of Aspects 9-23, wherein identifying the one or more sets of SSB indexes associated with the set of valid RACH occasions further comprises identifying an SSB index, of a set of SSB indexes associated with SBFD symbols, associated with at least one RACH occasion in the uplink sub-band in accordance with a mapping sequence that skips one or more uplink symbols.

Aspect 25: The method of any of Aspects 9-24, wherein identifying the set of valid RACH occasions further comprises identifying a RACH occasion in the uplink sub-band as invalid in accordance with a synchronization signal block in a downlink sub-band overlapping the RACH occasion in time.

Aspect 26: A method of wireless communication performed by a user equipment (UE), comprising: receiving a sub-band full duplex (SBFD) configuration that indicates an uplink sub-band in a downlink symbol; receiving a random access channel (RACH) configuration, wherein the RACH configuration indicates a plurality of RACH occasions including at least one RACH occasion in the uplink sub-band; identifying a set of valid RACH occasions of the plurality of RACH occasions, wherein the set of valid RACH occasions includes one or more valid RACH occasions on one or more uplink symbols, and wherein the at least one RACH occasion in the uplink sub-band is invalid for the UE having an SBFD-aware status; and transmitting a RACH message on a valid RACH occasion of the set of valid RACH occasions.

Aspect 27: The method of Aspect 26, wherein the RACH configuration comprises a single RACH configuration for SBFD symbols and non-SBFD symbols.

Aspect 28: The method of any of Aspects 26-27, wherein identifying the set of valid RACH occasions further comprises identifying the at least one RACH occasion in the uplink sub-band as invalid in association with the UE having the SBFD-aware status.

Aspect 29: The method of any of Aspects 26-28, wherein receiving the RACH configuration further comprises receiving the RACH configuration via at least one of: a UE-specific RACH configuration, or a cell-common RACH configuration.

Aspect 30: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-29.

Aspect 31: An apparatus for wireless communication at a device, the apparatus comprising one or more memories and one or more processors coupled to the one or more memories, the one or more processors configured to cause the device to perform the method of one or more of Aspects 1-29.

Aspect 32: An apparatus for wireless communication, the apparatus comprising at least one means for performing the method of one or more of Aspects 1-29.

Aspect 33: A non-transitory computer-readable medium storing code for wireless communication, the code comprising instructions executable by one or more processors to perform the method of one or more of Aspects 1-29.

Aspect 34: A non-transitory computer-readable medium storing a set of instructions for wireless communication, the set of instructions comprising one or more instructions that, when executed by one or more processors of a device, cause the device to perform the method of one or more of Aspects 1-29.

Aspect 35: A device for wireless communication, the device comprising a processing system that includes one or more processors and one or more memories coupled with the one or more processors, the processing system configured to cause the device to perform the method of one or more of Aspects 1-29.

Aspect 36: An apparatus for wireless communication at a device, the apparatus comprising one or more memories and one or more processors coupled to the one or more memories, the one or more processors individually or collectively configured to cause the device to perform the method of one or more of Aspects 1-29.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. An apparatus for wireless communication at a user equipment (UE), comprising:
one or more memories; and
one or more processors, coupled to the one or more memories, configured to cause the UE to:
receive a sub-band full duplex (SBFD) configuration that indicates an uplink sub-band in a downlink symbol;
receive a random access channel (RACH) configuration, wherein the RACH configuration indicates a plurality of RACH occasions;
identify a set of valid RACH occasions of the plurality of RACH occasions, wherein the set of valid RACH occasions includes one or more first valid RACH occasions on one or more uplink symbols and one or more second valid RACH occasions on the uplink sub-band in the downlink symbol;
identify a first set of synchronization signal block (SSB) indexes associated with the one or more first valid RACH occasions;
identify, after identifying the first set of SSB indexes, a second set of SSB indexes associated with the one or more second valid RACH occasions; and
transmit a RACH message on a valid RACH occasion of the set of valid RACH occasions, the valid RACH occasion being associated with an SSB index of the first set of SSB indexes or the second set of SSB indexes.

2. The apparatus of claim 1, wherein the one or more processors, to cause the UE to identify the second set of SSB indexes, are configured to cause the UE to identify the second set of SSB indexes associated with the one or more second valid RACH occasions in the uplink sub-band in accordance with an SBFD-aware status of the UE.

3. The apparatus of claim 1, wherein the one or more processors, to cause the UE to identify the second set of SSB indexes, are configured to cause the UE to identify an SSB index, of the second set of SSB indexes, as associated with the one or more second valid RACH occasions in the uplink sub-band in accordance with a particular SSB index on the one or more uplink symbols.

4. The apparatus of claim 3, wherein the particular SSB index is an SSB index of a nearest preceding uplink symbol of the one or more uplink symbols.

5. The apparatus of claim 3, wherein the particular SSB index is an SSB index of a nearest following uplink symbol of the one or more uplink symbols.

6. The apparatus of claim 1, wherein the one or more processors, to cause the UE to identify the second set of SSB indexes, are configured to cause the UE to identify an SSB index, of the second set of SSB indexes, as associated with the one or more second valid RACH occasions in the uplink sub-band in accordance with a mapping sequence that skips the one or more uplink symbols.

7. The apparatus of claim 1, wherein the one or more processors, to cause the UE to identify the set of valid RACH occasions, are configured to cause the UE to identify a RACH occasion in the uplink sub-band as invalid in accordance with a synchronization signal block overlapping the RACH occasion in time.

8. The apparatus of claim 1, wherein the UE is associated with a connected state, and wherein the RACH configuration comprises at least one of:
a UE-specific RACH configuration, or
a cell-common RACH configuration.

9. An apparatus for wireless communication at a network node, comprising:
one or more memories; and
one or more processors, coupled to the one or more memories, configured to cause the network node to:
transmit a sub-band full duplex (SBFD) configuration that indicates an uplink sub-band in a downlink symbol;
transmit a random access channel (RACH) configuration, wherein the RACH configuration indicates a plurality of RACH occasions;
identify a set of valid RACH occasions of the plurality of RACH occasions;
identify one or more sets of synchronization signal block (SSB) indexes associated with the set of valid RACH occasions;
monitor for a RACH message on a valid RACH occasion of the set of valid RACH occasions, the valid RACH occasion being associated with an SSB index of the one or more sets of SSB indexes.

10. The apparatus of claim 9, wherein the plurality of RACH occasions includes at least one RACH occasion in the uplink sub-band.

11. The apparatus of claim 10, wherein the at least one RACH occasion in the uplink sub-band is invalid for a user equipment having an SBFD-aware status and a user equipment having a non-SBFD-aware status.

12. The apparatus of claim 9, wherein the one or more processors, to cause the network node to transmit the RACH configuration, are configured to cause the network node to transmit the RACH configuration in accordance with a rule indicating that the network node is not allowed to configure RACH occasions in the uplink sub-band in the downlink symbol.

13. The apparatus of claim 9, wherein the RACH configuration comprises a single RACH configuration for a first user equipment (UE) having an SBFD-aware status and a second UE without the SBFD-aware status.

14. The apparatus of claim 13, wherein, for the first UE, the set of valid RACH occasions includes at least one RACH occasion in the uplink sub-band of the downlink symbol, and wherein, for the second UE, the set of valid RACH occasions includes no RACH occasion in the uplink sub-band of the downlink symbol.

15. The apparatus of claim 13, wherein the RACH configuration is configured such that SSB indexes, associated with RACH occasions valid for the first UE, are aligned with SSB indexes associated with RACH occasions valid for the second UE.

16. The apparatus of claim 13, wherein the one or more processors, to cause the network node to transmit the RACH configuration, are configured to cause the network node to transmit the RACH configuration via at least one of:
a UE-specific RACH configuration, or
a cell-common RACH configuration.

17. The apparatus of claim 9, wherein the RACH configuration comprises a first RACH configuration indicating one or more first RACH occasions for SBFD symbols and a second RACH configuration indicating one or more second RACH occasions for non-SBFD symbols.

18. The apparatus of claim 17, wherein a first RACH occasion, of the one or more first RACH occasions, that occurs in an uplink symbol, is invalid for a user equipment having an SBFD-aware status.

19. The apparatus of claim 17, wherein the one or more processors, to cause the network node to transmit the RACH configuration, are configured to cause the network node to transmit the first RACH configuration via first cell-common or UE specific signaling and the second RACH configuration via second cell-common or UE specific signaling.

20. The apparatus of claim 17, wherein the one or more processors, to cause the network node to identify the one or more sets of SSB indexes associated with the set of valid RACH occasions, are configured to cause the network node to:
identify a first set of SSB indexes associated with the one or more second RACH occasions; and
identify, after the first set of SSB indexes, a second set of SSB indexes associated with the one or more first RACH occasions.

21. The apparatus of claim 9, wherein the one or more processors, to cause the network node to identify the one or more sets of SSB indexes associated with the set of valid RACH occasions, are configured to cause the network node to identify a particular SSB index, of a set of SSB indexes associated with SBFD symbols, associated with at least one RACH occasion in the uplink sub-band in accordance with a given SSB index on one or more uplink symbols.

22. The apparatus of claim 21, wherein the given SSB index is an SSB index of a nearest preceding uplink symbol.

23. The apparatus of claim 21, wherein the given SSB index is an SSB index of a nearest following uplink symbol.

24. The apparatus of claim 9, wherein the one or more processors, to cause the network node to identify the one or more sets of SSB indexes associated with the set of valid RACH occasions, are configured to cause the network node to identify an SSB index, of a set of SSB indexes associated with SBFD symbols, associated with at least one RACH occasion in the uplink sub-band in accordance with a mapping sequence that skips one or more uplink symbols.

25. The apparatus of claim 9, wherein the one or more processors, to cause the network node to identify the set of valid RACH occasions, are configured to cause the network node to identify a RACH occasion in the uplink sub-band as invalid in accordance with a synchronization signal block in a downlink sub-band overlapping the RACH occasion in time.

26. An apparatus for wireless communication at a user equipment (UE), comprising:
one or more memories; and
one or more processors, coupled to the one or more memories, configured to cause the UE to:
receive a sub-band full duplex (SBFD) configuration that indicates an uplink sub-band in a downlink symbol;
receive a random access channel (RACH) configuration, wherein the RACH configuration indicates a plurality of RACH occasions including at least one RACH occasion in the uplink sub-band;
identify a set of valid RACH occasions of the plurality of RACH occasions, wherein the set of valid RACH occasions includes one or more valid RACH occasions on one or more uplink symbols, and wherein the at least one RACH occasion in the uplink sub-band is invalid for the UE having an SBFD-aware status; and
transmit a RACH message on a valid RACH occasion of the set of valid RACH occasions.

27. The apparatus of claim 26, wherein the RACH configuration comprises a single RACH configuration for SBFD symbols and non-SBFD symbols.

28. The apparatus of claim 26, wherein the one or more processors, to cause the UE to identify the set of valid RACH occasions, are configured to cause the UE to identify the at least one RACH occasion in the uplink sub-band as invalid in association with the UE having the SBFD-aware status.

29. The apparatus of claim 26, wherein the one or more processors, to cause the UE to receive the RACH configuration, are configured to cause the UE to receive the RACH configuration via at least one of:
a UE-specific RACH configuration, or
a cell-common RACH configuration.

30. A method of wireless communication performed by a user equipment (UE), comprising:
receiving a sub-band full duplex (SBFD) configuration that indicates an uplink sub-band in a downlink symbol;
receiving a random access channel (RACH) configuration, wherein the RACH configuration indicates a plurality of RACH occasions;
identifying a set of valid RACH occasions of the plurality of RACH occasions, wherein the set of valid RACH occasions includes one or more first valid RACH occasions on one or more uplink symbols and one or more second valid RACH occasions on the uplink sub-band in the downlink symbol;
identifying a first set of synchronization signal block (SSB) indexes associated with the one or more first valid RACH occasions;
identifying, after identifying the first set of SSB indexes, a second set of SSB indexes associated with the one or more second valid RACH occasions; and
transmitting a RACH message on a valid RACH occasion of the set of valid RACH occasions, the valid RACH occasion being associated with an SSB index of the first set of SSB indexes or the second set of SSB indexes.
